(19) United States
(12) Patent Application Publication
(10) Pub. No.: US 2025/0374384 A1
(43) Pub. Date: Dec. 4, 2025

(54) COOKING APPLIANCE

(71) Applicant: LG Electronics Inc., Seoul (KR)

(72) Inventors: Dong Hun KIM, Seoul (KR); Young Jin KIM, Seoul (KR); Jeongkil KIM, Seoul (KR); Junhwan JANG, Seoul (KR); Geon KWON, Seoul (KR); Hansu LEE, Seoul (KR)

(73) Assignee: LG Electronics Inc., Seoul (KR)

(21) Appl. No.: 19/211,953

(22) Filed: May 19, 2025

(30) Foreign Application Priority Data
May 30, 2024 (KR) 10-2024-0070856
Dec. 16, 2024 (KR) 10-2024-0187151
Dec. 16, 2024 (KR) 10-2024-0187153
Dec. 16, 2024 (KR) 10-2024-0187155

(51) Int. Cl. H05B 6/64

(52) U.S. Cl. CPC H05B 6/6414; H05B 6/6423; H05B 6/6447

(57) ABSTRACT

A cooking appliance includes a main body including a cavity, and a door that is configured to open and close the cavity. The door includes a display module located at a front portion of the door, an outlet configured to discharge air flowing inside the door, and a panel configured to guide a flow direction of air discharged from the outlet downward to an outside of the cooking appliance.

### CROSS-REFERENCE TO RELATED APPLICATIONS

This application claims priority to and benefit of Korean Patent Application No. 10-2024-0070856, filed on May 30, 2024, Korean Patent Application No. 10-2024-0187151, filed on Dec. 16, 2024, Korean Patent Application No. 10-2024-0187153, filed on Dec. 16, 2024, and Korean Patent Application No. 10-2024-0187155, filed on Dec. 16, 2024, all of which are hereby expressly incorporated by reference herein.

### BACKGROUND

### Field

The present disclosure relates to a cooking appliance, and more particularly, to a cooking appliance installed above a heating cooking apparatus.

### Description of Related Art

Content described in this section merely provides background information on the present disclosure and does not constitute prior art. Rather, the content in this section merely describes related art.

A cooking appliance is a home appliance that cooks food using a microwave, which is a type of cooking appliance that uses an electromagnetic wave, and/or heater heat. The cooking appliance may generally include a cavity, which is a space in which the food is placed and cooked, and a door that opens and closes the cavity.

When the cooking appliance is installed indoors, it is necessary to consider efficient use of the cooking appliance, saving of an installation space, and the like.

For this reason, the cooking appliance may be disposed at a location adjacent to another heating cooking appliance, for example, a heating oven, a gas stove, and the like. Specifically, the cooking appliance may be disposed above the heating cooking apparatus.

When the cooking appliance is disposed above the heating cooking apparatus, a user may conveniently cook the food by reducing a movement in an environment in which the cooking appliance and the heating cooking apparatus are adjacent to each other. In addition, heat, oil vapor, and the like generated from the heating cooking apparatus may be discharged to an outside using the cooking apparatus as a hood.

For example, a display may be mounted on a front surface of the door equipped in the cooking appliance to provide various information to the user. The user may identify a cooked state of the food via the display.

In addition, when the display is connected to another home appliance to serve as a hub of the home appliance, information other than the cooking of the food may be obtained via the display. In addition, a command necessary for the cooking and various other commands may be input to the display by a touch method.

### SUMMARY

The present disclosure may provide a cooking appliance including a door having a structure that may efficiently cool a display.

Further, the present disclosure may provide a cooking appliance including various sensing devices that sense external situations.

Further, the present disclosure may provide a cooking appliance having a structure in which sensing devices are disposed at a front portion of a door.

Further, the present disclosure may provide a cooking appliance having a structure in which a front coupling portion installed in a door and equipped with various sensing devices is stably coupled to an outer panel.

Further, the present disclosure may provide a cooking appliance having a structure with improved ease of assembly, by allowing a sensing device equipped in a front coupling portion to be easily coupled to another component.

Further, the present disclosure may provide a cooking appliance having a structure in which a component to which a sensing device is assembled is stably coupled to an outer panel.

Further, the present disclosure may provide a cooking appliance having a structure in which a performance of sensing ambient illuminance is improved.

However, the present disclosure are not limited to the above-mentioned embodiments. Embodiments with other advantages according to the present disclosure that are not mentioned may be understood based on following descriptions, and may be more clearly understood based on embodiments according to the present disclosure. Further, it will be easily understood that the purposes and advantages according to the present disclosure may be realized using means shown in the claims or combinations thereof.

An embodiment of the cooking appliance may include a main body with a cavity defined therein, and a door that opens and closes the cavity.

The door may include a display module disposed at a front portion of the door, an outlet constructed to discharge air flowing inside the door therethrough, and a panel constructed to guide a flow direction of air discharged forward from the outlet downward.

The outlet may include a first outlet defined at an upper portion of the door and overlapping the panel in a front and rear direction. The panel may be disposed to cover a front side of the first outlet.

The display module may include a display that displays an image thereon. The panel may be disposed to at least partially overlap a bezel formed at an edge of the display in the front and rear direction.

Further, the panel may be disposed so as to protrude further forward than the display and may be disposed so as to be spaced apart from the display in the front and rear direction.

The door may include a front coupling portion protruding forward and including the panel. A gap allowing air to be discharged therethrough may be defined between a lower portion of the front coupling portion and a front surface of the display.

Additionally, air flowing inside the door may be discharged forward via the first outlet, and may be blocked by the panel and change the flow direction thereof to the downward direction of the door.

A lower end of the panel may protrude further downward than a lower end of the first outlet.

Air discharged forward from the first outlet may collide with a rear surface of the panel and flow in a changed direction toward an open lower portion between the panel and the first outlet.

Furthermore, air discharged from the first outlet may change the flow direction thereof by the panel and may be discharged downward of the door, so that at least a portion thereof may come into contact with a front surface of the display.

The panel may include a coupling panel whose longitudinal direction is directed in a lateral direction of the door. A rear surface of the coupling panel may protrude further forward than a front surface of the display.

The display module may include a display that displays an image thereon. The display module may include an outer panel disposed at the rear of the display, wherein the display is mounted on the outer panel.

In addition, the outer panel may include a first outlet defined at an upper portion of the outer panel and allowing air flowing inside the door to be discharged to the outside therethrough. The outer panel may include a second outlet defined at a lower portion of the outer panel and allowing air flowing inside the door to be discharged to the outside therethrough.

The panel may be disposed in front of the first outlet and may be disposed to overlap the first outlet in a front and rear direction.

Further, a lower end of the panel may protrude further downward than a lower end of the first outlet, so that air discharged from the first outlet may collide with the panel and may be guided by the panel to change a flow path thereof to the downward direction.

The door may include a display module disposed at a front portion of the door, a sensing module that is disposed on an upper front portion of the display module and senses a presence of a user, and a panel positioned on the upper front portion of the display module and constructed to cover the sensing module.

The sensing module may include a first camera that films a space in front of the cooking appliance.

The sensing module may include an illuminance sensor that senses external illuminance.

Additionally, the sensing module may include a human sensor that senses the presence of the user in front of the cooking appliance.

The panel may include a coupling panel having a longitudinal direction directed in a lateral direction of the door, wherein the first camera, the illuminance sensor, and the human sensor are disposed on the coupling panel. The panel may include a cover panel formed in a shape corresponding to the coupling panel and constructed to cover at least a portion of the coupling panel.

In another embodiment, the panel may include a coupling panel having a longitudinal direction directed in a lateral direction of the door.

In another embodiment, the coupling panel may include a first camera.

In another embodiment, the coupling panel may include an illuminance sensor.

In another embodiment, the coupling panel may include a human sensor.

In another embodiment, the panel may include a coupling panel formed in a shape corresponding to the coupling panel.

In another embodiment, the cover panel may be disposed to cover at least a portion of the coupling panel.

Furthermore, the panel may include a cover window that is disposed between the coupling panel and the cover panel and covers a front side of the sensing module.

More specifically, the panel may include a cover window disposed between the coupling panel and the cover panel and constructed to cover front sides of the first camera, the illuminance sensor, and the human sensor.

The cover window may include an exposure hole defined at a location corresponding to the human sensor and constructed to expose a portion of a front surface of the human sensor to the outside.

The coupling panel may include a first through-hole defined at a location corresponding to the first camera. The coupling panel may include a second through-hole defined to be laterally spaced apart from the first through-hole and defined at a location corresponding to the illuminance sensor. The coupling panel may include a third through-hole defined to be laterally spaced apart from the second through-hole and defined at a location corresponding to the human sensor.

The coupling panel may include a first holder protruding rearward from a rear surface thereof and formed to surround the third through-hole, wherein the human sensor is mounted on the first holder.

In another embodiment, the coupling panel may include a first holder protruding rearward from the rear surface thereof.

In another embodiment, the coupling panel may include a first holder formed to surround a third through-hole.

In another embodiment, the coupling panel may include a first holder where a human sensor is mounted.

The sensing module may include a sensing board having a front surface where the illuminance sensor and the human sensor are mounted.

In another embodiment, the sensing module may include a sensing board having a front surface where an illuminance sensor is mounted.

In another embodiment, the sensing module may include a sensing board where a human sensor is mounted.

Further, the coupling panel may include a first fastening protrusion protruding rearward from the rear surface of the coupling panel and fastened to the sensing board by a coupling mechanism. The coupling panel may include a first mounting protrusion protruding rearward from the rear surface of the coupling panel and disposed at a location spaced apart from the first fastening protrusion, wherein an end of the sensing board is mounted on the first mounting protrusion.

In addition, the exposure hole may be defined at a location overlapping the third through-hole. An area size of the exposure hole may be smaller than an area size of the human sensor.

In another embodiment, the exposure hole may be defined at a location overlapping the third through-hole.

In another embodiment, an area size of the exposure hole may be smaller than an area size of the human sensor.

The first holder may include a base protruding portion protruding from the coupling panel and formed in a circumferential shape. The first holder may include an additional protruding portion further protruding from a portion of the base protruding portion and formed in an arcuate shape.

Further, the door may include a panel that guides a flow direction of air discharged from a first outlet. The door may include a cooling flow channel that is disposed at the rear of the display module and has a flow channel where air for cooling flows defined therein.

A door in another embodiment may include a display module disposed at a front portion of the door, and a sensing module that is disposed on a front portion of the display module and senses an external situation.

An outer panel may include a first outlet disposed at an upper portion of the outer panel and allowing air flowing inside the door to be discharged to the outside therethrough. The outer panel may include a second outlet disposed at a lower portion of the outer panel and allowing air flowing inside the door to be discharged to the outside therethrough. A panel may be disposed in front of the first outlet, and may be disposed to overlap the first outlet in a front and rear direction.

A lower end of the panel may protrude further downward than a lower end of the first outlet, so that air discharged from the first outlet may collide with the panel and may be guided by the panel to change a flow path thereof to the downward direction.

Additionally, air forced to flow by a blower fan may be introduced from an inlet, flow downward of the door, be introduced into the blower fan, pass through the blower fan in the front and rear direction of the door, and branch in a vertical direction at a location ahead of an air guide, so that a portion of air may flow upward of the door and be discharged to the first outlet, and the rest of air may flow downward of the door and be discharged to the second outlet.

Air discharged from the first outlet may be guided by the panel to flow downward. At least a portion of air discharged from the first outlet may come into contact with a front surface of the display, and at least a portion of air discharged from the second outlet may flow forward of the door.

Because of such a structure, air discharged from the first outlet may be in direct contact with the front surface of the display and cool the front surface of the display.

The sensing module may include a first camera that films a space in front of the cooking appliance, and a sensing board that is disposed to be spaced apart from the first camera and equipped with a sensor that senses an external situation.

The sensing board may include an illuminance sensor that senses external illuminance. The sensing board may include a human sensor that senses the presence of the user in front of the cooking appliance.

The panel may include a coupling panel having a longitudinal direction directed in a lateral direction of the door, wherein the first camera and the sensing board are disposed on the coupling panel. The panel may include a cover panel formed in a shape corresponding to the coupling panel and constructed to cover at least a portion of the coupling panel.

The cover panel may include a front surface and a side portion formed by being bent from the front surface at an edge of the front surface. The front surface may include a fourth through-hole defined at a location corresponding to a window seating groove.

Furthermore, the cover panel may include an upper bent portion formed by being bent from an upper end of the front surface. The cover panel may include a bent coupling portion extending from at least one of the side portion and the upper bent portion and bent to couple the cover panel with the coupling panel.

The bent coupling portion may include a first sub-coupling portion formed on at least one of the side portion and the upper bent portion and bent to be coupled to the coupling panel. The bent coupling portion may include a second sub-coupling portion formed on the side portion and bent to define a screw fastening hole defined to correspond to a screw fastening boss formed on the coupling panel.

As the first sub-coupling portion and the second sub-coupling portion are bent or coupled to the coupling panel by the coupling mechanism, the cover panel and the coupling panel may be firmly coupled to each other.

The door may include a sensing module that is disposed on an upper front portion of the display module and senses a presence of a user. The door may include a panel positioned on the upper front portion of the display module. The panel may be constructed to cover the sensing module.

Additionally, the sensing module may include a first camera that films a space in front of the cooking appliance. The sensing module may include an illuminance sensor that senses external illuminance. The sensing module may include a human sensor that senses the presence of the user in front of the cooking appliance.

The panel may include a coupling panel having a longitudinal direction directed in a lateral direction of the door. At least one of the first camera, the illuminance sensor, and the human sensor may be disposed on the coupling panel. The panel may include a cover panel formed in a shape corresponding to the coupling panel. The cover panel may be constructed to cover at least a portion of the coupling panel.

The coupling panel may include a first holder protruding rearward from a rear surface thereof. The first holder may be formed to surround the third through-hole. The human sensor may be mounted on the first holder.

The first holder may include a base protruding portion protruding from the coupling panel and formed in a circumferential shape. The first holder may include an additional protruding portion further protruding from a portion of the base protruding portion and formed in an arcuate shape.

Further, a space to avoid collision between the illuminance sensor and the first holder may be defined at a step formed by the base protruding portion and the additional protruding portion.

The coupling panel may include a panel hook protruding rearward from a rear surface thereof. The panel hook may include a plurality of panel hooks spaced apart from each other in a longitudinal direction. The outer panel may include an outer hook coupling hole defined at a location corresponding to the panel hook. The panel hook may be inserted into and coupled to the outer hook coupling hole.

By inserting the panel hook of the coupling panel into the outer hook coupling hole of the outer panel, the front coupling portion may be placed at a designed location on the outer panel and remained at the corresponding location.

The door may include a sensing module that is disposed on an upper front portion of the display module and senses an external situation. The door may include a panel positioned on the upper front portion of the display module and constructed to cover the sensing module.

In addition, the panel may include a coupling panel having a longitudinal direction directed in a lateral direction of the door and coupled with the sensing module. The door may include a cover panel formed in a shape corresponding to the coupling panel and constructed to cover at least a portion of the coupling panel.

The sensing module may include a first camera that is coupled to a coupling panel and films a space in front of the cooking appliance. The sensing module may include an illuminance sensor that is disposed on the coupling panel, is disposed to be spaced apart from the first camera in a lateral direction, and senses external illuminance. The sensing module may include a human sensor that is coupled to the coupling panel, is disposed to be spaced apart from the illuminance sensor in the lateral direction, and senses the presence of the user in front of the cooking appliance.

Furthermore, the coupling panel may include a first through-hole where a first camera is inserted. The coupling panel may include a second through-hole defined to be laterally spaced apart from the first through-hole and defined at a location corresponding to the illuminance sensor. The coupling panel may include a third through-hole defined to be laterally spaced apart from the second through-hole and defined at a location corresponding to the human sensor.

The second through-hole may be defined such that a diameter thereof increases forward from a location adjacent to the illuminance sensor.

The coupling panel may include a light guide that protrudes rearward from the rear surface of the coupling panel and has a second through-hole defined therein.

The light guide may be formed such that a diameter of an inner surface thereof increases forward from a location adjacent to the illuminance sensor.

In other words, the light guide and the second through-hole may be formed in a cone shape in which a diameter of a front side is greater than that of a rear side.

The light guide may include a reflective plate that has an inner surface formed to surround the second through-hole and reflects at least a portion of light entering the second through-hole.

Light entering the second through-hole from the outside may be repeatedly reflected by the reflective plate and enter the illuminance sensor.

Furthermore, the reflective plate may be formed in the cone shape to reflect light incident on a front entrance of the second through-hole, thereby increasing a light reception angle of light incident on the second through-hole.

In the cooking appliance according to the present disclosure, air discharged from the first outlet may form the air curtain like air discharged from the second outlet to prevent oil vapor or the like from being adhered to the front surface of the display.

In addition, air discharged from the first outlet may be changed in the flow direction by the panel and discharged in the downward direction of the door, so that at least a portion thereof may come into contact with the front surface of the display.

Because of such a structure, air discharged from the first outlet may directly come into contact with the front surface of the display to cool the front surface of the display. Therefore, the front surface and the rear surface of the display are both cooled by air, so that cooling efficiency may be significantly improved compared to a case in which only the rear surface of the display is cooled.

Further, the cooking appliance may include, as a sensing device, at least one of the first camera that films the space ahead, the illuminance sensor that senses the ambient illuminance, and the human sensor that senses the presence of the user ahead.

Such sensing devices may enable the user to have a video meeting with another person at a remote location via the cooking device, control the brightness of the lighting of the cooking appliance based on the ambient illuminance, and provide convenience beyond simple cooking to the user, such as sensing the presence of the user and performing a required operation.

Further, in the cooking appliance according to the present disclosure, as the first sub-coupling portion and the second sub-coupling portion formed to protrude from the cover panel are bent or coupled to the coupling panel by the coupling mechanism, the cover panel and the coupling panel may be firmly coupled to each other.

Because of such a structure, the number of screw fastening structures for coupling the cover panel and the coupling panel having relatively great area sizes to each other may be significantly reduced to improve ease of assembly of the components, and the number of necessary fastening mechanisms may be reduced to improve external aesthetics of the cooking appliance.

Further, in the cooking appliance according to the present disclosure, the first holder may have the two-stage protruding structure including the base protruding portion and the additional protruding portion. Further, the space for avoiding the illuminance sensor and the first holder from colliding with each other may be defined at the step formed by the base protruding portion and the additional protruding portion.

Because of such a structure, the sensing module may be easily assembled to the coupling panel. Therefore, ease of assembly of the entire cooking appliance may be improved, thereby saving an assembly time.

Further, in the cooking appliance according to the present disclosure, the panel hook of the coupling panel may be inserted into the outer hook coupling hole of the outer panel. As a result, the front coupling portion may be placed at a designed location on the outer panel and may be remained at the corresponding location.

In such a state, the operation of fixing the third fastening protrusion of the coupling panel to the outer panel using the coupling mechanism may be easily performed. This is because the operator does not need a separate operation to maintain the coupling panel at the designed location to fasten the coupling mechanism. Therefore, the ease of assembly of the entire cooking appliance may be improved, and thus, the assembly time may be saved.

The cooking appliance may include, as sensing devices, the first camera that films the space ahead, the illuminance sensor that senses the ambient illuminance, and the human sensor that senses the presence of the user ahead.

Such sensing devices may enable the user to have a video meeting with another person at a remote location via the cooking device. In addition, the sensing devices may control the brightness of the lighting of the cooking appliance based on the ambient illuminance, and provide convenience beyond simple cooking to the user, such as sensing the presence of the user and performing a required operation.

Further, in the cooking appliance according to the present disclosure, the light guide may be formed such that diameters of an inner surface thereof and the second through-hole increase in the forward direction from locations adjacent to the illuminance sensor. That is, the light guide and the second through-hole may be formed in a cone shape in which a diameter of a front portion is greater than a diameter of a rear portion.

Because of such a structure, the light reception angle at which external light is incident on the illuminance sensor may be widened, compared to a case in which the diameters of the front and rear portions of the second through-hole are equal to each other. Accordingly, the light reception of the illuminance sensor may be improved, so that the illuminance sensor may accurately measure the external illuminance, and thus, performance thereof may be improved.

Further, in the cooking appliance according to the present disclosure, light incident to the second through-hole from the outside may be repeatedly reflected by the reflective plate and be incident to the illuminance sensor. Accordingly, the light reception amount of the illuminance sensor may be increased by the reflection plate, compared to the case in which the reflection plate is not present, thereby improving the performance of the illuminance sensor.

Further, in the cooking appliance according to the present disclosure, the reflective plate may be formed in the cone shape to reflect light incident to the front entrance of the second through-hole to increase the light reception angle of light incident to the second through-hole, thereby effectively increasing the light reception amount of the illuminance sensor.

In addition to the above-described effects, specific effects of the present disclosure will be described together while describing specific matters for implementing the present disclosure.

### BRIEF DESCRIPTION OF DRA WINGS

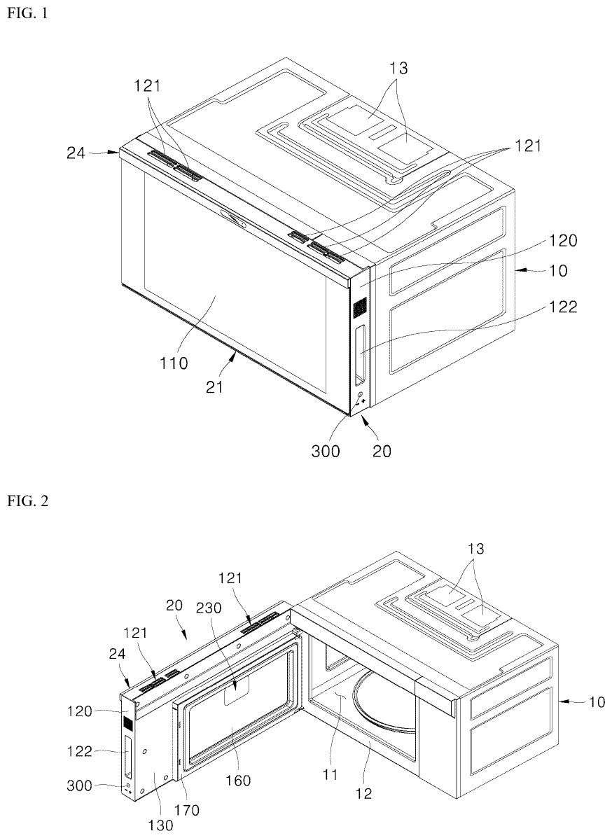

FIG. 1 is a perspective view illustrating a cooking appliance according to an embodiment.

FIG. 2 is a view illustrating a state in which a door is opened in FIG. 1.

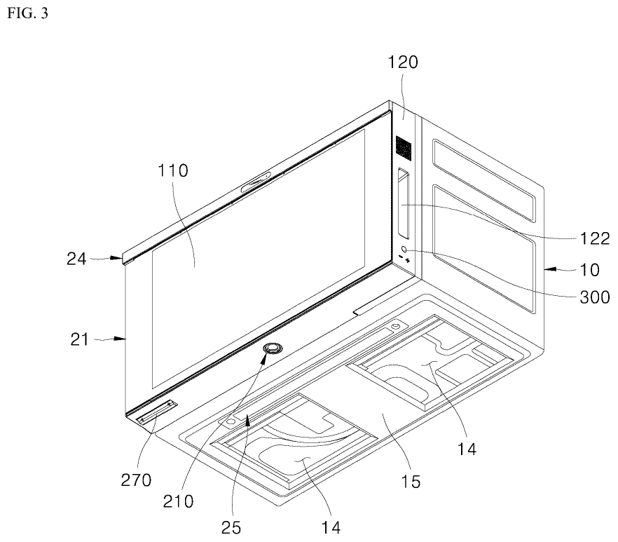

FIG. 3 is a view of FIG. 1 in another direction.

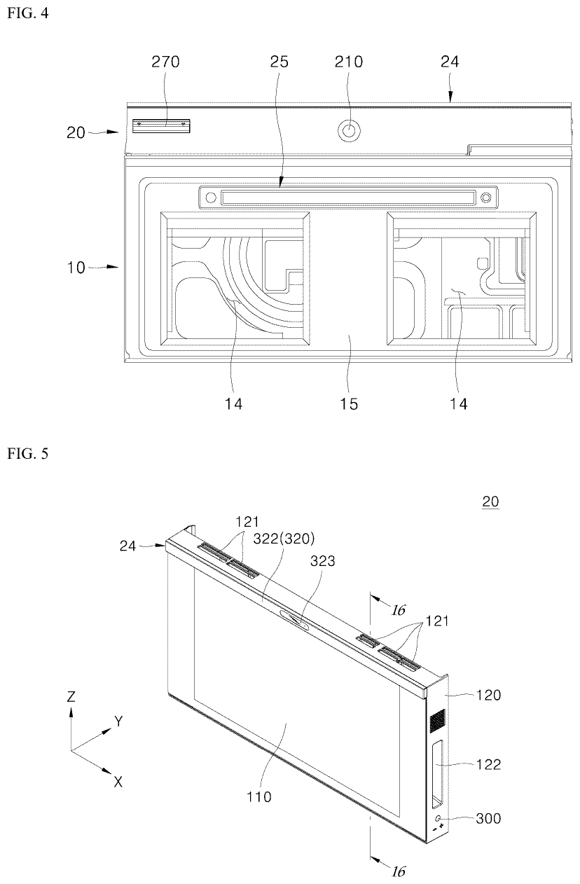

FIG. 4 is a bottom view of a cooking appliance according to an embodiment.

FIG. 5 is a perspective view illustrating a door of a cooking appliance according to an embodiment.

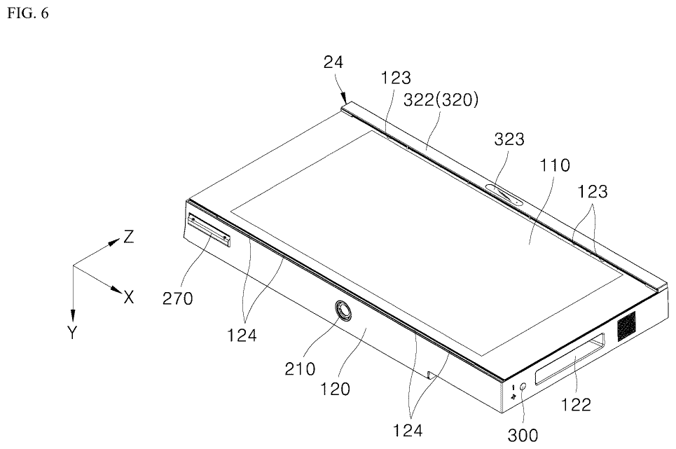

FIG. 6 is a view of FIG. 5 in another direction.

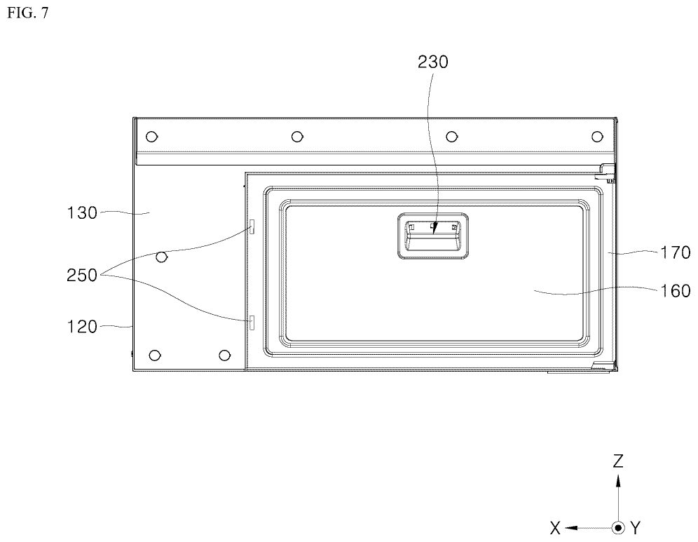

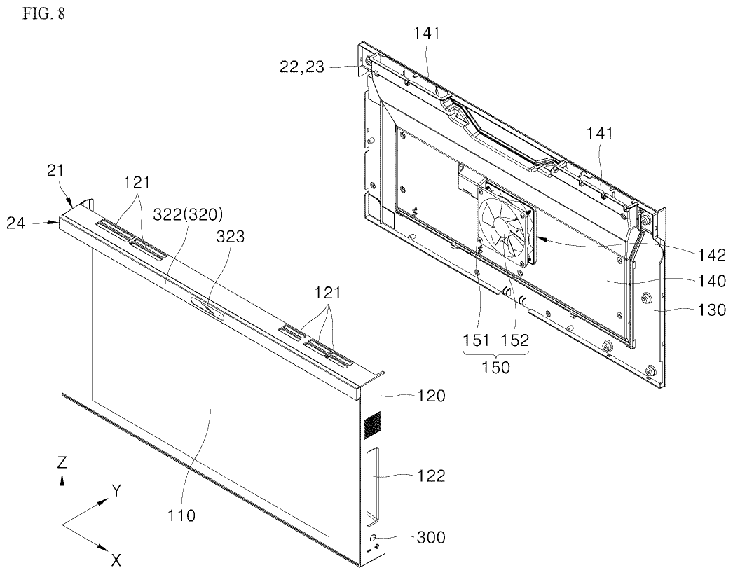

FIG. 7 is a rear view of a door.

FIG. 8 is an exploded perspective view of a portion of a door according to an embodiment.

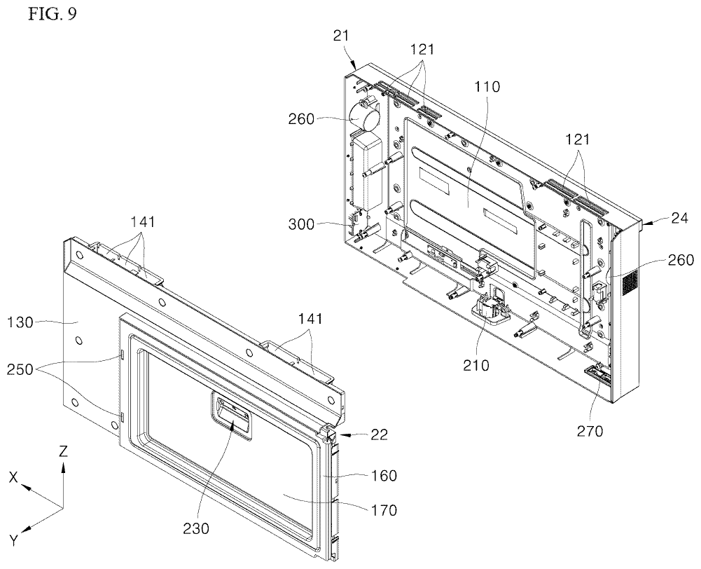

FIG. 9 is a view of FIG. 8 in another direction.

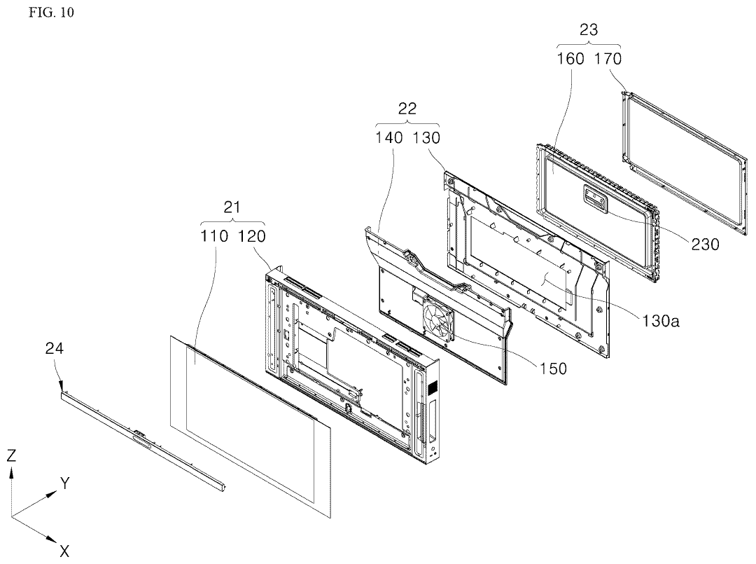

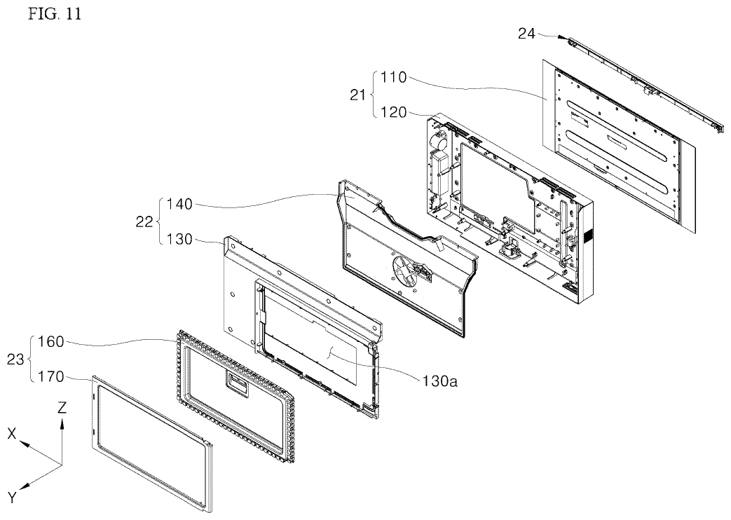

FIG. 10 is an exploded perspective view of a door according to an embodiment.

FIG. 11 is a view of FIG. 10 in another direction.

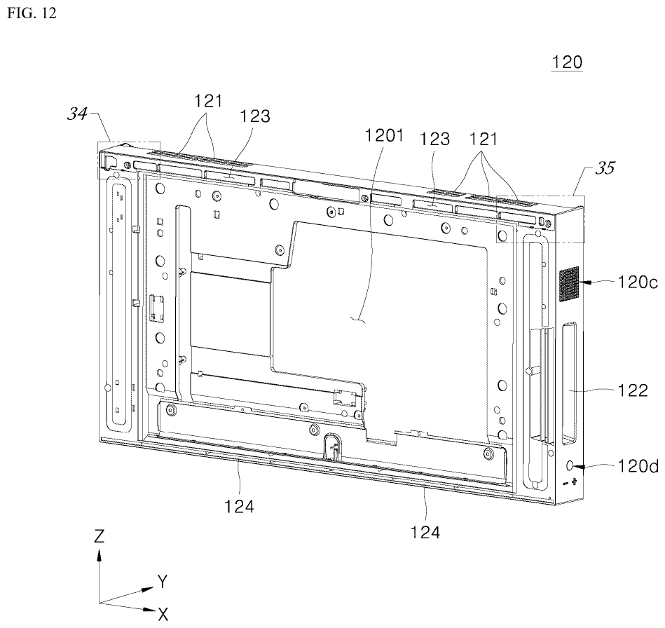

FIG. 12 is a perspective view illustrating an outer panel according to an embodiment.

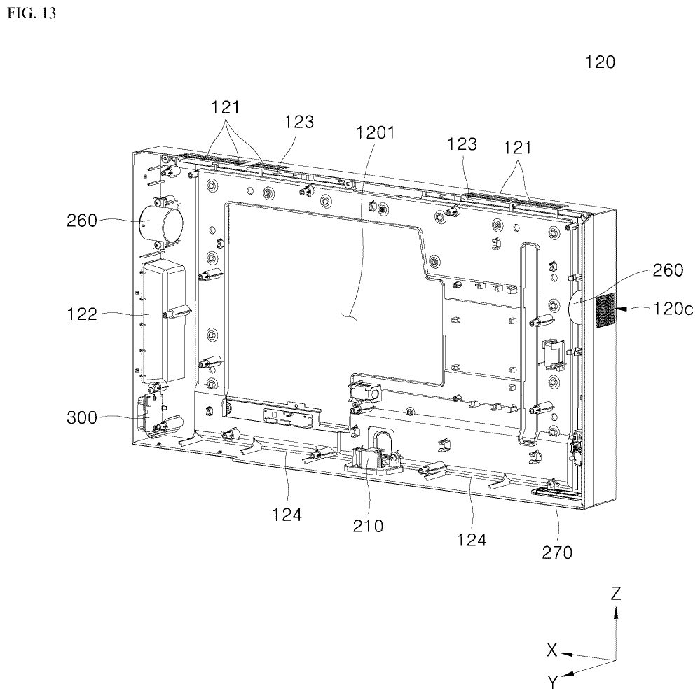

FIG. 13 is a view of FIG. 12 in another direction.

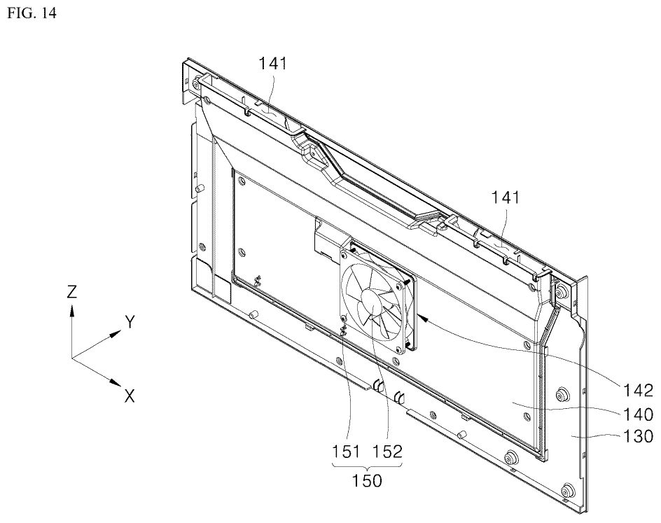

FIG. 14 is a view illustrating an inner panel and an air guide according to an embodiment.

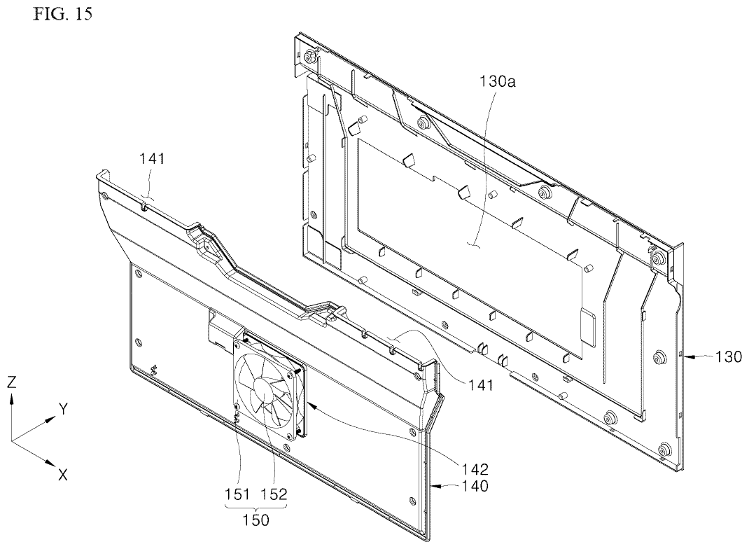

FIG. 15 is an exploded perspective view of FIG. 14.

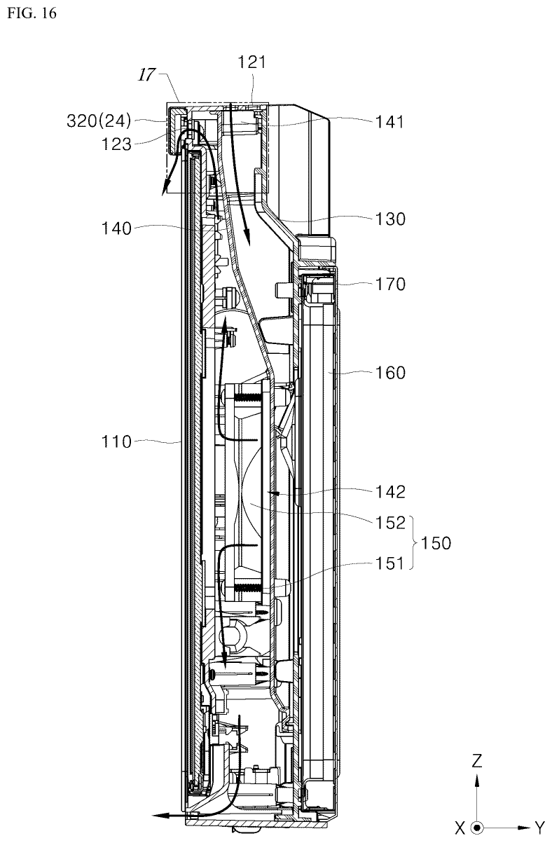

FIG. 16 is a side cross-sectional view of a door viewed in a direction 16-16 in FIG. 5.

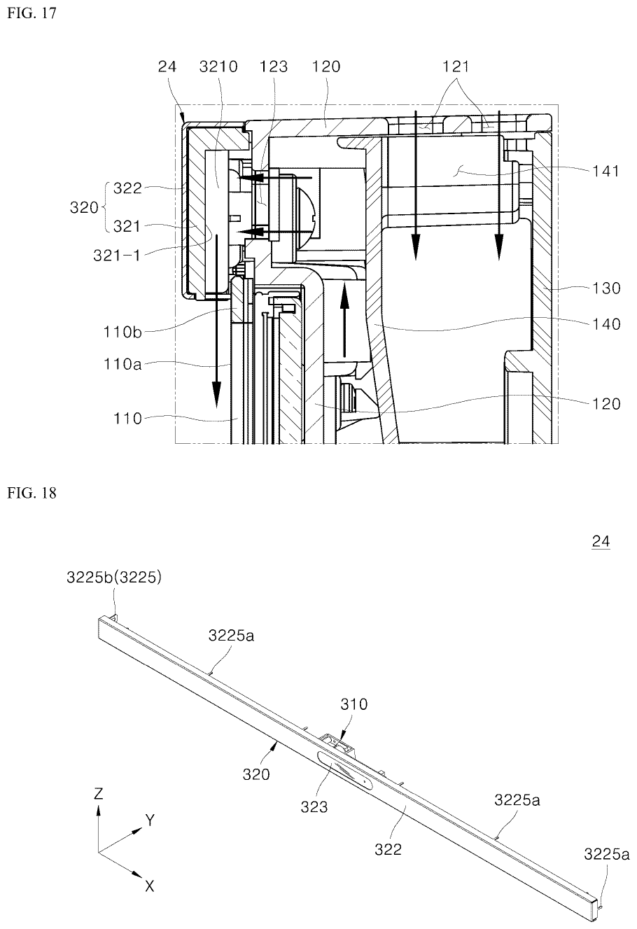

FIG. 17 is an enlarged view of a portion 17 in FIG. 16.

FIG. 18 is a perspective view illustrating a front coupling portion according to an embodiment.

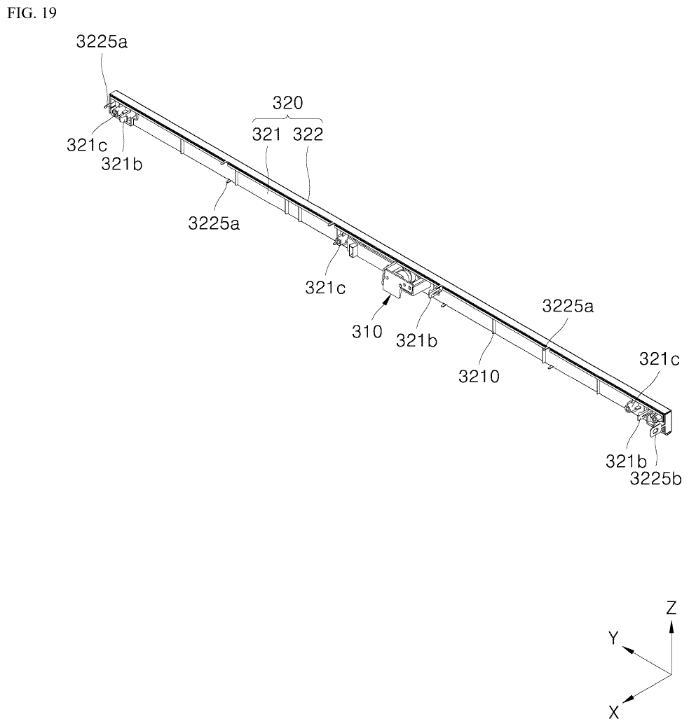

FIG. 19 is a view of FIG. 18 in another direction.

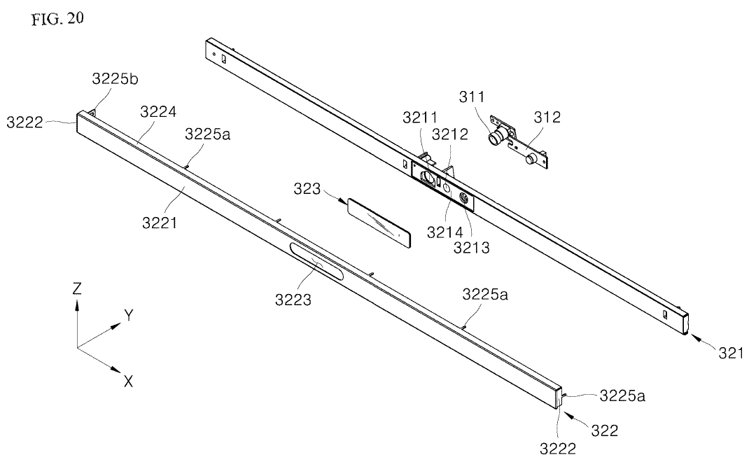

FIG. 20 is an exploded perspective view of FIG. 18.

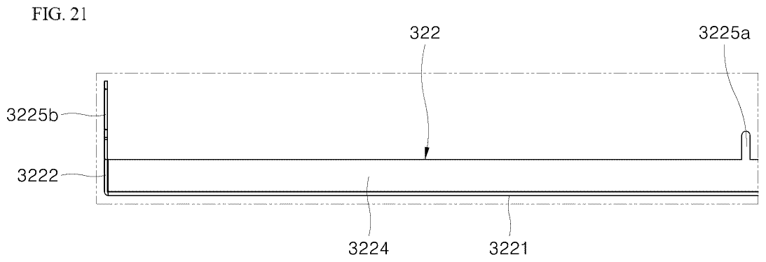

FIG. 21 is a plan view illustrating a portion of a cover panel according to an embodiment.

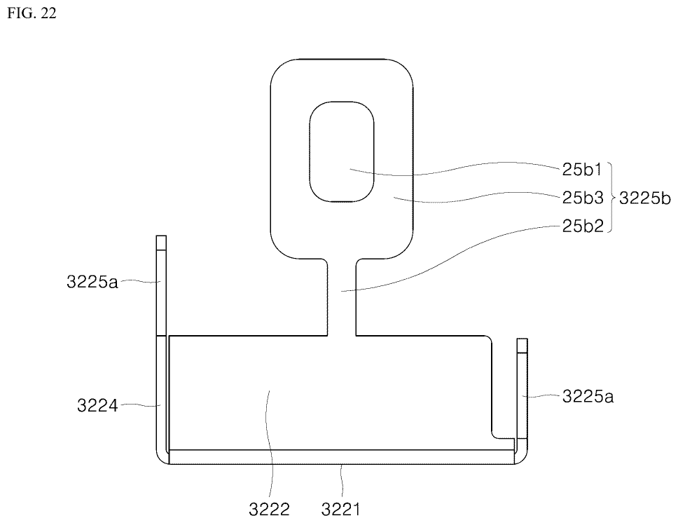

FIG. 22 is a side view of FIG. 21.

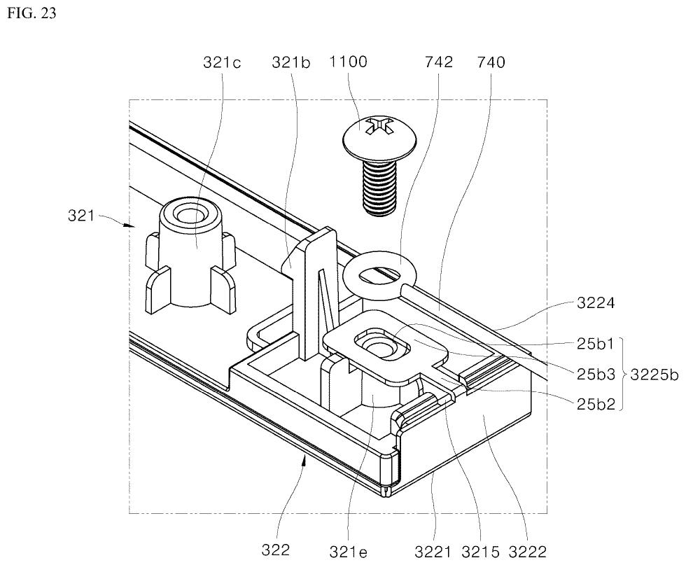

FIG. 23 is a view for illustrating a coupling structure of a second sub-coupling portion.

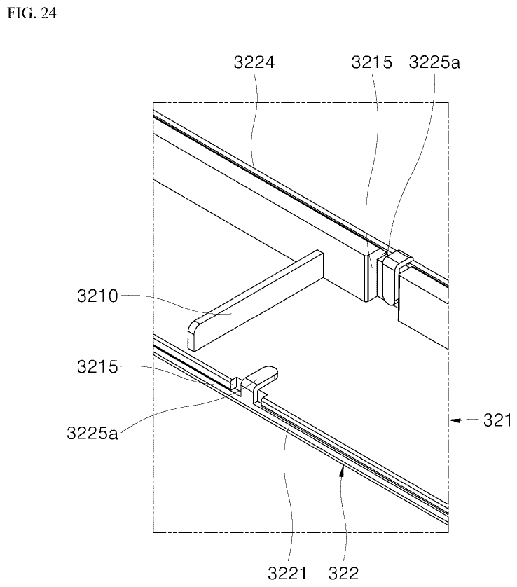

FIG. 24 is a diagram for illustrating a coupling structure of a first sub-coupling portion.

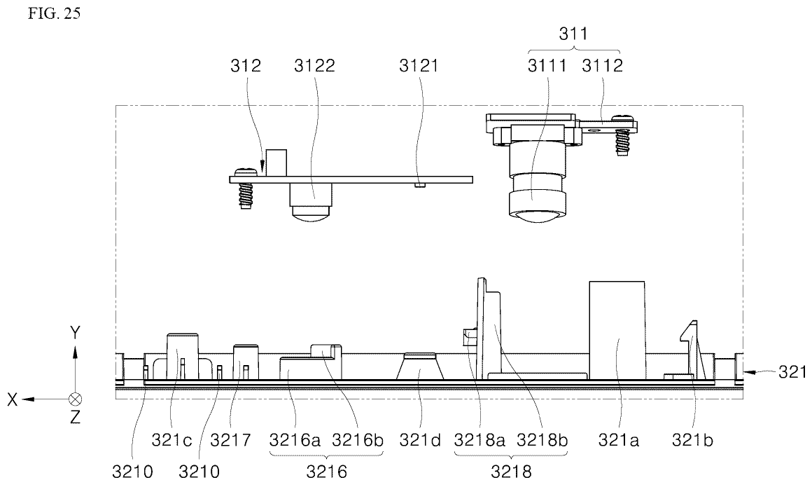

FIG. 25 is a diagram for illustrating a coupling structure between a first camera, a sensing board, and a coupling panel.

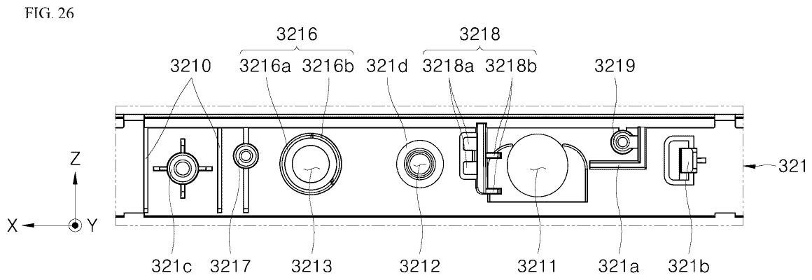

FIG. 26 is a front view illustrating a portion of a coupling panel according to an embodiment.

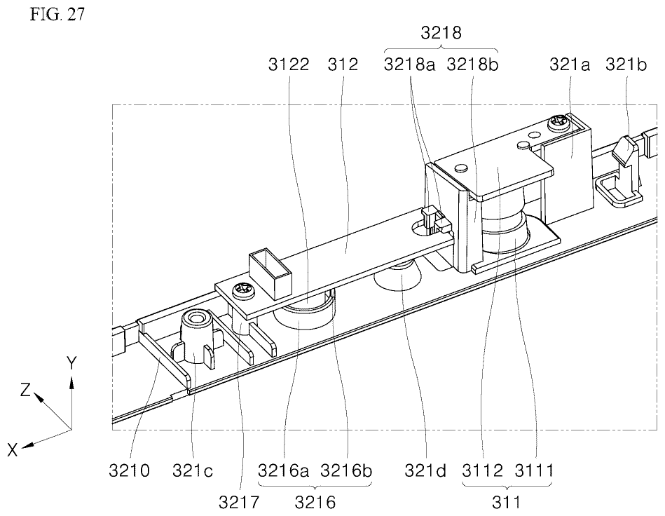

FIG. 27 is a perspective view illustrating a state in which a first camera and a sensing board are coupled to a coupling panel.

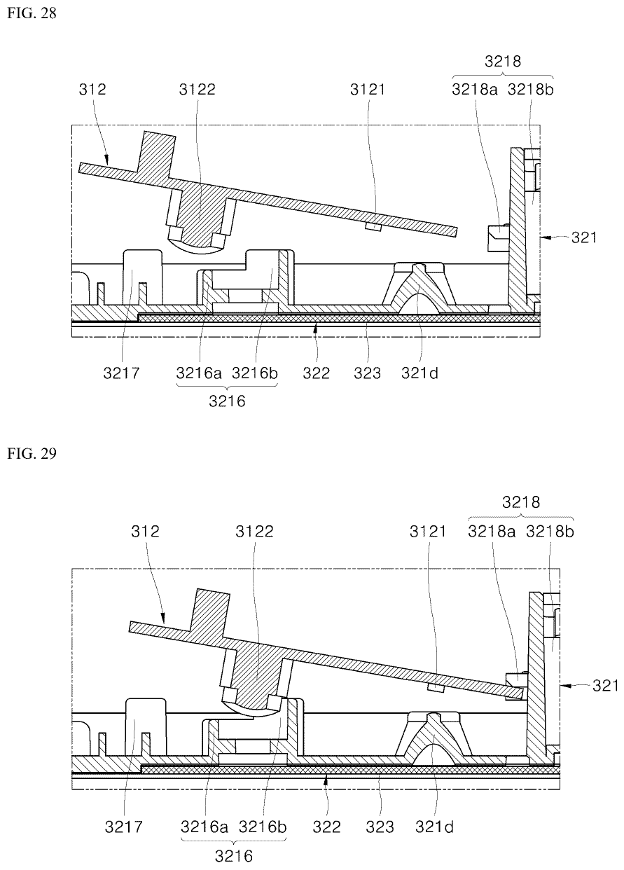

FIGS. 28, 29, and 30 are diagrams for illustrating a process of assembling a sensing board and a coupling panel.

FIG. 31 is a perspective view illustrating a cover window according to an embodiment.

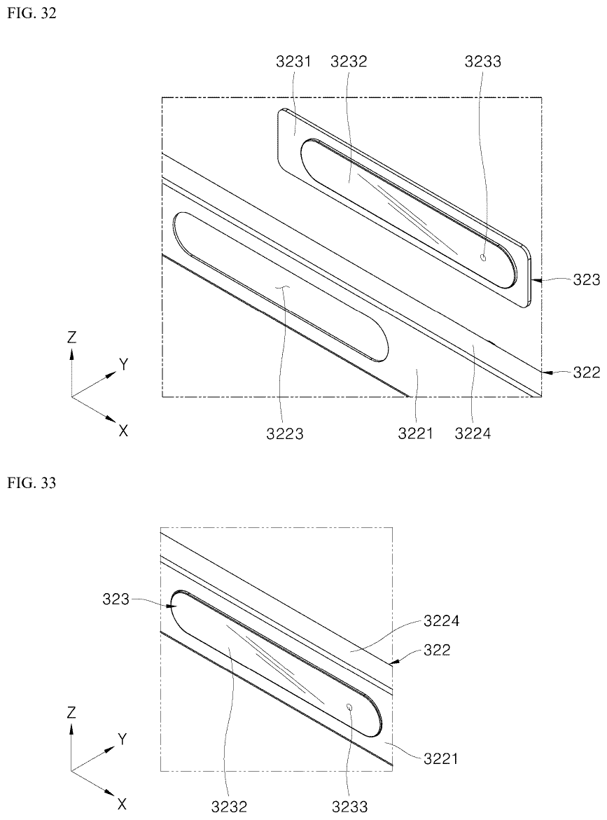

FIG. 32 is an exploded perspective view illustrating a cover window and a cover panel according to another embodiment.

FIG. 33 is a perspective view illustrating a coupled state of a cover window and a cover panel in FIG. 32.

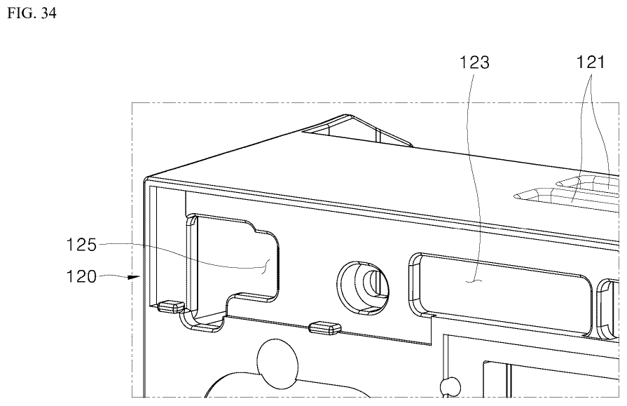

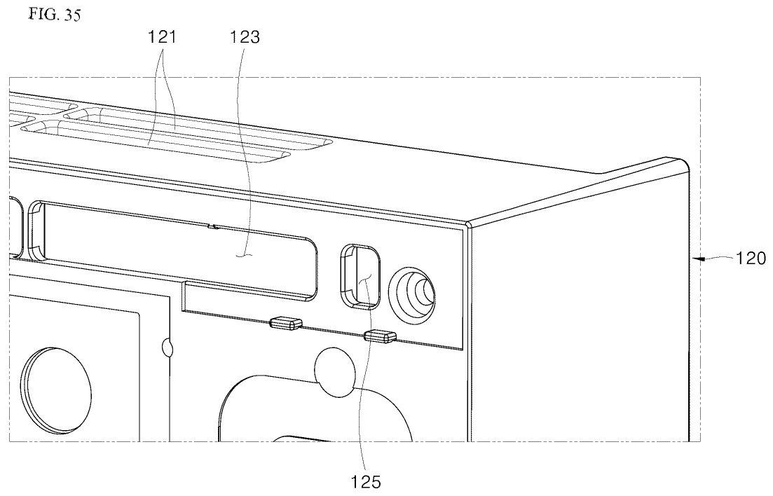

FIG. 34 is an enlarged view of a portion 34 in FIG. 12.

FIG. 35 is an enlarged view of a portion 35 in FIG. 12.

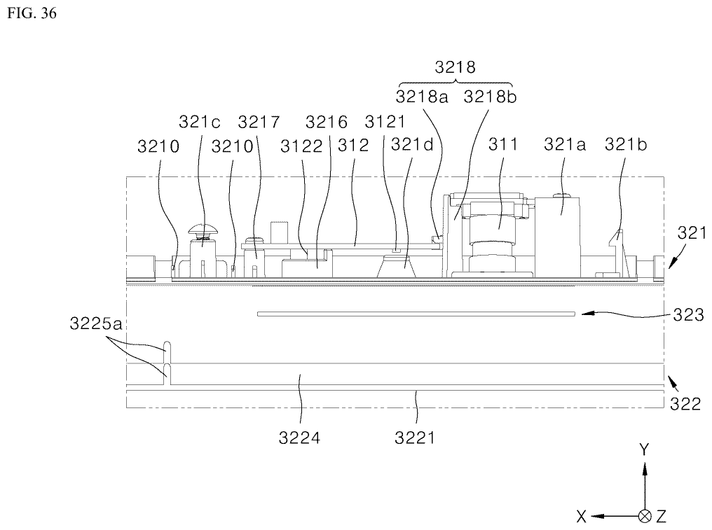

FIG. 36 is an exploded view illustrating a portion of a front coupling portion according to an embodiment.

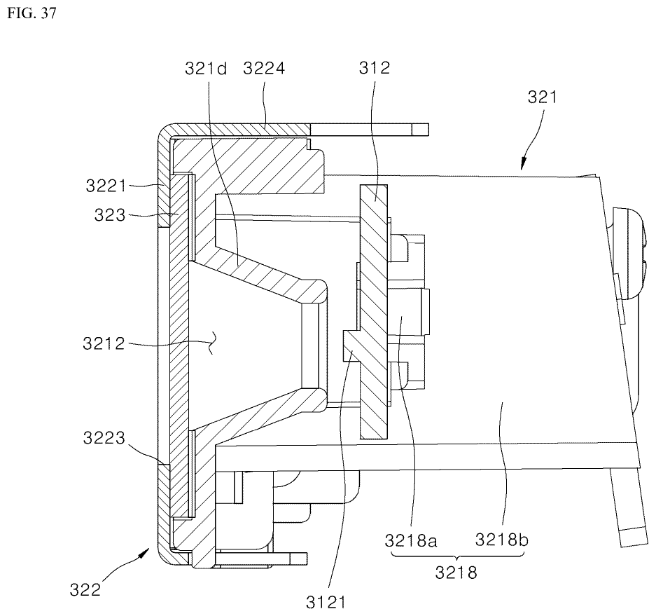

FIG. 37 is a cross-sectional view illustrating a portion of an illuminance sensor in a front coupling portion.

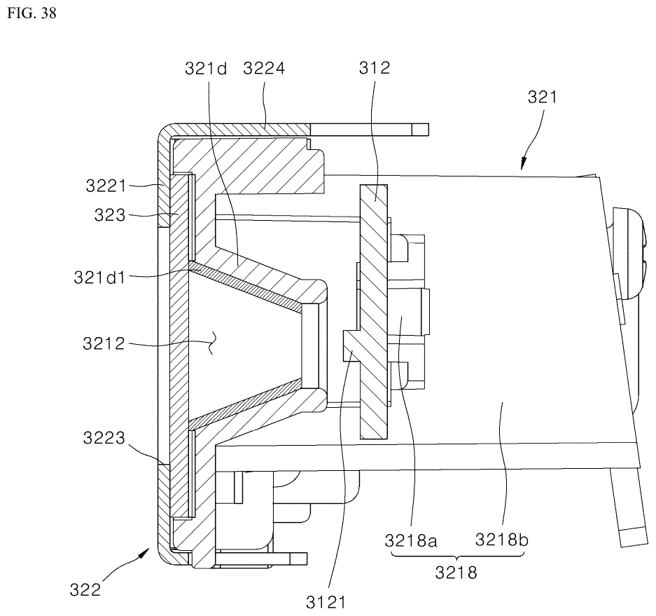

FIG. 38 is a cross-sectional view for illustrating a light guide according to another embodiment.

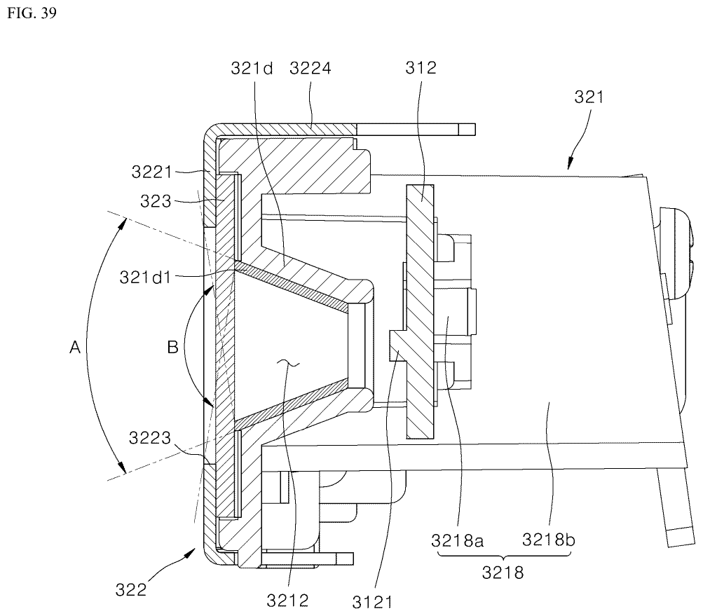

FIG. 39 is a view for illustrating a light reception angle according to each embodiment of a light guide.

### DETAILED DESCRIPTIONS

The above-mentioned purposes, features, and advantages will be described in detail later with reference to the attached drawings, so that those skilled in the art in the technical field to which the present disclosure belongs may easily practice the technical ideas of the present disclosure. In describing the present disclosure, when it is determined that a detailed description of the publicly known technology related to the present disclosure may unnecessarily obscure the gist of the present disclosure, the detailed description thereof will be omitted. Hereinafter, an embodiment according to the present disclosure will be described in detail with reference to the attached drawings. In the drawings, identical reference numerals are used to indicate identical or similar components.

Although first, second, and the like are used to describe various components, these components are not limited by such terms. Such terms are only used to distinguish one component from another component, and unless specifically stated to the contrary, a first component may also be a second component.

Throughout the present document, unless otherwise stated, each component may be singular or plural.

As used herein, singular expressions include plural expressions, unless the context clearly dictates otherwise. In the present application, terms such as “composed of” or “include” should not be construed as necessarily including all of various components or steps described herein, and should be interpreted as being able to not including some of the components or the steps and further including additional components or steps.

Throughout the present disclosure, “A and/or B” means A, B, or A and B, unless otherwise specified, and “C to D” means C inclusive to D inclusive unless otherwise specified.

Throughout the present document, a “vertical direction” refers to a vertical direction of a cooking appliance in a state in which the cooking appliance is installed to be used on a daily basis. A “left and right direction” means a direction orthogonal to the vertical direction, and a front and rear direction means a direction orthogonal to both the vertical direction and the left and right direction. A “lateral direction” has the same meaning as the left and right direction, and such terms are able to be used interchangeably herein.

FIG. 1 is a perspective view illustrating a cooking appliance according to an embodiment. FIG. 2 is a view illustrating a state in which a door 20 is opened in FIG. 1.

The cooking appliance according to an embodiment may be disposed above a location where a heating cooking appliance, for example, a heating oven, a gas stove, and the like, is disposed, at a location spaced apart from the heating cooking appliance in the vertical direction. However, the present disclosure is not limited thereto. The cooking appliance may only be disposed partially above the heating cooking appliance or located in a vicinity of the heating cooking appliance.

Because of such an arrangement of the cooking appliance, a user may conveniently use cooking apparatuses including the cooking appliance. In addition, the cooking appliance may serve as a hood of the heating cooking apparatus disposed below. In this case, the cooking appliance may include components for the use as the hood.

The cooking appliance may cook food using a microwave, which is a type of cooking appliance that uses an electromagnetic wave, and/or heater heat. The cooking appliance may include a main body 10 in which the cavity 11 is formed, and a door 20 that opens and closes the cavity 11.

The food to be cooked may be placed in the cavity 11. The door 20 may be disposed in front of the cavity 11 and pivotably mounted on the main body 10 to open and close the cavity 11. The door 20 may be mounted to an edge portion of the main body 10.

Additionally, the cooking appliance may serve as the hood for discharging gaseous foreign substances discharged from the heating cooking apparatus disposed below to an outside of the cooking appliance. To this end, a vent hole 13 for discharging moisture, oil vapor, and the like generated in the heating cooking appliance disposed below the cooking appliance to the outside may be defined at an upper portion of the main body 10.

The main body 10 may further include a front panel 12 that is disposed at an edge of an entrance of the cavity 11, and closes the cavity 11 by being disposed such that one surface thereof faces one surface of a choke member 170 when the door 20 is closed.

The front panel 12 may be disposed to surround the entrance edge of the cavity 11 and protrude with a predetermined width. Accordingly, when the door 20 is closed, an edge of the door 20 and the cavity 11 may overlap each other. Additionally, a length of the front panel 12 may correspond to a length of the cavity 11. However, the present disclosure is not limited thereto.

Because of such a structure, the front panel 12 may seal the cavity 11 in the state in which the door 20 is closed, thereby suppressing oil, moisture, oil vapor, and the like generated during a cooking process of the food placed in the cavity 11 from being leaked to the outside via the entrance of the cavity 11.

FIG. 3 is a view of FIG. 1 in another direction. FIG. 4 is a bottom view of a cooking appliance according to an embodiment.

A suction unit 14 for sucking moisture, oil vapor, and the like rising from the heating cooking appliance may be disposed at a lower portion of the main body 10. Accordingly, the cooking appliance may serve as the hood that sucks air discharged from the heating cooking appliance disposed below the cooking appliance and discharges the air to the outside.

The suction unit 14 and the vent hole 13 may be in communication with each other, and thus, gas such as oil vapor introduced into the suction unit 14 may be discharged to the outside via the vent hole 13, and the vent hole 13 may be in communication with a duct connected to the outside.

In one example, the cavity 11 of the cooking appliance is formed not to be in communication with the suction unit 14 and the vent hole 13, so that gas such as oil vapor introduced from the suction unit 14 may be discharged to the outside of the main body 10 directly via the vent hole 13 without being introduced into the cavity 11.

A bottom panel 15 may be disposed at the lower portion of the main body 10, and the suction unit 14 may be formed to extend through the bottom panel 15 and be in communication with the vent hole 13. In addition, more than one suction unit 14 may be located on the bottom panel 15. For example, in an embodiment, at least two symmetrical suction units 14 may be located on the bottom panel 15.

Additionally, the bottom panel 15 may include a lighting unit 25 that irradiates light in a downward direction. Such a lighting unit may be formed, for example, in a shape long in the lateral direction of the cooking appliance. By the light irradiated from the lighting unit 25, the user may conveniently use the heating cooking appliance disposed below the cooking appliance.

FIG. 5 is a perspective view illustrating the door 20 of the cooking appliance according to an embodiment. FIG. 6 is a view of FIG. 5 in another direction. FIG. 7 is a rear view of the door 20. FIG. 8 is an exploded perspective view of a portion of the door 20 according to an embodiment. FIG. 9 is a view of FIG. 8 in another direction.

The door 20 may include a display module 21, a cooling flow path 22, and a shielding portion 23. The display module 21 may be disposed at a front portion of the door 20, and the user may view inside of the cavity 11 of the cooking appliance through the display module 21.

The cooling flow path 22 may be disposed at the rear of the display module 21, and a flow path through which air for cooling flows may be formed therein. Air introduced into the door 20 may flow inside the door 20 via the cooling flow path 22 to cool the door 20.

The shielding portion 23 may be disposed at the rear of the cooling flow path 22, and may shield the electromagnetic wave generated in the main body 10. The shielding portion 23 may protect the user by blocking the electromagnetic wave generated in the cavity 11 and propagated to the outside of the cooking appliance.

For example, the shielding portion 23 may serve to block the electromagnetic wave (a microwave) generated to cook the food in the main body 10 from being discharged to the outside of the door 20, thereby protecting the user from exposure to the electromagnetic wave.

The cooling flow path 22 may be disposed to cool electronic components mounted inside the door 20, including a display 110 mounted on the display module 21. In the cooling flow path 22 air that cools the door 20 may flow inside. The display 110 may be formed in a thin shape and may be disposed such that an area thereof occupies a significant portion of one surface of the door 20.

Accordingly, the display 110 is formed to occupy a significant portion of a front surface area of the door 20, and the area of the display 110 is increased, so that visibility to the user may be improved. The user may conveniently check the various information via the display 110 formed as a large screen.

Because the display 110 is enlarged, an amount of heat generated may increase. Therefore, the display 110 needs to be effectively cooled on the door 20. In an embodiment, the cooling flow path 22 through which cooling air flows may be separately disposed.

The cooling flow path 22 may be disposed at the rear of the display 110, so that cooling air may flow, and thus the display module 20 may be effectively cooled by air flowing through the cooling flow path 22. In addition, heating components mounted in the display module 21 may also be cooled by air flowing through the cooling flow path 22. That is, the cooling flow path 22 may cool the display module 21 equipped with the display 110 and various other heating components.

To effectively cool the display 110, an entirety of the display 110 needs to be exposed to air flowing through the cooling flow path 22. In addition, the air flow passing through the cooling flow path 22 and discharged to the outside of the door 20 needs to form an air curtain to block heat and oil vapor rising from the heating cooking appliance disposed below the cooking appliance.

To this end, air flowing through the cooling flow path 22 may be branched from the inside of the cooling flow path 22 so as to be discharged upward and downward of the display module 21.

As cooling air is branched from the inside of the cooling flow path 22 and discharged upward and downward of the display module 21, cooling air may flow while coming into contact with an entirety of a rear surface of the display 110 to effectively cool the display 110.

In addition, as cooling air is discharged upward and downward of the display module 21, the air curtain is effectively formed around the display and the door 20, so that heat and oil vapor rising from the heating cooking appliance disposed below the cooking appliance may be effectively blocked by the air curtain, and redirected toward the suction unit 14.

The display module 21 may be equipped with the display 110, a camera, and other electronic components, and the cooling flow path 22 may be equipped with electronic components such as a blower 150 operated by a motor. Accordingly, to protect the user and the electronic components from the electromagnetic wave, the shielding portion 23 that shields the electromagnetic wave generated in the main body may be disposed at the rear of the cooling flow path 22.

In the display module 21, the display 110 and various electronic components may be disposed. Further, the cooling flow path 22 in which a flow path of air that cools the display module 21 is formed may be disposed at the rear of the display module 21, and the shielding portion 23 that shields the electromagnetic wave from reaching the electronic components equipped in the display module 21 may be disposed at the rear of the cooling flow path 22, thereby protecting components inside the display module 21 from the electromagnetic wave generated in the main body.

In an embodiment, the display module 21 may provide the various information to the user, and increase convenience by being located at a front surface of the cooking appliance. Specifically, in an embodiment, the display module 21 may be located at a forefront of the door 20. In addition, in an embodiment, a structure is required to effectively cool the components such as the display 110 equipped in the display module 21, to form the flow path of cooling air for forming the air curtain around the door 20 while effectively cooling the inside of the door 20 equipped with the display 110 and the like, and to protect the electronic components mounted in the door 20 from the electromagnetic wave.

To meet such a need, the display module 21 may be disposed at the forefront of the door 20, the cooling flow path 22 may be disposed at the rear of the display module 21, and the shielding portion 23 may be disposed at the rear of the cooling flow path 22.

That is, to implement the door structure according to the above-described embodiment, the display module 21, the cooling flow path 22, and the shielding portion 23, need to be sequentially arranged from a front side to a rear side of the door 20.

The display module 21 may include a first outlet 123 and a second outlet 124. The first outlet 123 may be disposed at an upper portion of the display module 21, and air flowing inside the display module 21 may be discharged to the outside via the first outlet 123. In addition, a length of the first outlet 123 may correspond to a length of the door 20. However, the preset disclosure is not limited thereto.

The second outlet 124 may be disposed at a lower portion of the display module 21, and air flowing inside the display module 21 may be discharged to the outside via the second outlet 124. In addition, a length of the second outlet 124 may correspond to the length of the door 20. However, the preset disclosure is not limited thereto.

That is, air flowing inside the door 20 may be discharged to the outside via the first outlet 123 and the second outlet 124 respectively disposed at the upper and lower portions of the door 20, and accordingly, air may flow through the entire inside of the door 20 to effectively cool the entire door 20.

In addition, the display module 21 may include the display 110 and an outer panel 120. The display 110 may be disposed on the front surface of the door 20 to display a video or an image.

The display 110 may display information necessary for the cooking and provide the information to the user. In addition, the display 110 may receive a user's command in a touch recognition method.

In one example, the display 110 may be communicatively connected to other home appliances, a camera disposed at a main door, a locking device, and the like. In addition, the display 110 may be communicatively connected to an external device required by the user.

The user may receive information necessary for operation of the home appliance, such as presence of a visitor from the display 110, and transmit commands to the home appliance and other devices connected to the display 110 using the display 110.

Accordingly, the door 20 including the display 110 may serve as a kind of an internet of things (IoT) hub that transmits the information regarding the home appliance and other devices necessary for living to the user and transmits user's commands to such devices.

The outer panel 120 may be disposed at the rear of the display 110, and the display 110 may be mounted thereon. The outer panel 120 may generally have a hollow 1201 and may be formed in a shape having a predetermined width in a front and rear direction of the door 20.

The hollow 1201 of the outer panel 120 may be closed by a rear surface of the display 110. Air flowing inside the outer panel 120 may hit the rear surface of the display 110 exposed through the hollow 1201 of the outer panel 120. Accordingly, air flowing inside the outer panel 120 may come into contact with the rear surface of the display 110 and cool the display 110.

In addition, air passing through a blower fan 152 may cool the heating components such as a speaker 260, a microphone 270, a printed circuit board, and the like, which are disposed to be exposed through the hollow 1201 of the outer panel 120.

Because the outer panel 120 has the above-described structure, it may have a built-in space, and various components may be built in the built-in space. A width of the door 20 in the front and rear direction may be determined almost by the outer panel 120.

Further, a first vent hole 121 through which air is introduced may be defined in an upper end of the outer panel 120. A plurality of first vent holes 121 may be defined. Each of the first vent holes 121 may be defined such that a plurality of slit-shaped holes are arranged at a distance. Because of such a structure, the external foreign substances may be somewhat suppressed from being introduced into the door 20 via the first vent hole 121. First vent holes 121 may be located at each end of the outer panel 120. However, the present disclosure is not limited thereto.

A handle 122 may be formed at one side of the outer panel 120 to be used when the user opens and closes the door 20. The handle 122 may be defined, for example, by recessing the side of the outer panel 120. However, other types of handles may be used.

A button device 300 may be mounted on one side of the outer panel 120, for example, directly below a location where the handle 122 is formed. The user may manipulate the button device 300 to supply electricity to the cooking appliance or cut off the supply of electricity. Detailed manipulation related to the operation of the cooking appliance may be performed by inputting a command to the display 110.

The outer panel 120 may support the various components such as the display 110, the speaker 260, the microphone 270, and the printed circuit board for communication or control, and may include the first vent hole 121 through which external air is introduced, and the first outlet 123 and the second outlet 124 through which air is discharged.

In one example, the door 20 may be equipped with camera. The image filmed by the camera may be reproduced on the display 110, and the user may view an image of an inside of the cavity 11 or a space under the cooking appliance via the display 110. The camera may include at least one of a first camera 311, a second camera 210, and a third camera 230.

The first camera 311 may be disposed at an upper front portion of the display module 21 to film a space ahead of the cooking appliance. The first camera 311 may film the user in front of the cooking appliance or an indoor space. Accordingly, the first camera 311 may be used for the user to make a video call with another person outside the main door or at another remote place using the display 110. The first camera 311 will be described in detail below.

The second camera 210 may be mounted at a lower portion of the outer panel 120 to film a state of a space under the door 20. Because the second camera 210 is mounted at the lower portion of the outer panel 120 such that a line of sight is directed to the space under the cooking appliance, it may film the heating cooking apparatus disposed below the cooking appliance. Alternatively, the second camera 210 may be utilized to monitor a state of the heating cooking appliance below the cooking appliance.

The user may observe the state of the heating cooking appliance and a cooked state of food on the heating cooking appliance by the image filmed by the second camera 210 and reproduced on the display 110.

The third camera 230 may be mounted on a frame 160, may be disposed to face the cavity 11, and may film the cavity 11. That is, a line of sight of the third camera 230 may be directed toward the cavity 11 to film a situation of the cavity 11. The user may observe a situation in which the food is cooked in the cavity 11 via the image filmed by the third camera 230.

Next, the door 20 may include a latch 250 mounted at a side of the frame 160 and formed to partially protrude from the frame 160. The latch 250 may be formed in a structure that is hooked to a groove defined in the front panel 12 of the door 20. The latch 250 may stably maintain the closed state of the door 20. The latch 250 may be provided on one side of the frame 160. However, the present disclosure is not limited thereto.

FIG. 10 is an exploded perspective view of the door 20 according to an embodiment. FIG. 11 is a view of FIG. 10 in another direction. The cooling flow path 22 may include an inner panel 130, an air guide 140, and the blower 150.

The inner panel 130 may be disposed at the rear of the outer panel 120 and may be mounted on the outer panel 120. The air guide 140 to be described later may be mounted on the inner panel 130. The inner panel 130 may define a space in which air sucked into the door 20 flows together with the air guide 140. Additionally, the air guide 140 may be mounted on the inner panel 130, and may be coupled to the frame 160 to provide the space in which air introduced into the door 20 flows.

The air guide 140 may be disposed between the outer panel 120 and the inner panel 130, and may be coupled to the inner panel 130. The air guide 140 may guide the flow of air introduced into the door 20 from the outside and define the space in which air may flow.

Next, the blower 150 may be mounted on the air guide 140. The blower 150 may forcibly allow air introduced into the air guide 140 to flow from a rear side to a front side of the air guide 140. The blower 150 may be located at a central portion of the air guide 140. However, the present disclosure is not limited thereto. The blower 150 may be located anywhere on the air guide 140.

The shielding portion 23 may include the frame 160 and the choke member 170. The frame 160 may be disposed at the rear of the inner panel 130, may be coupled to the inner panel 130, and may have one side pivotably coupled to the main body 10. The door 20 may pivot as the frame 160 pivots to open and close the cavity 11 of the cooking appliance.

The frame 160 may be coupled to the inner panel 130 to form a flow path of air for cooling, and at the same time, may have a shielding structure for preventing the electromagnetic wave leakage, that is, the choke member 170, to form an inner surface of the door 20.

The choke member 170 may be disposed at the rear of the frame 160, may be coupled to the frame 160, and may block external emission of the electromagnetic wave generated from the main body 10. The choke member 170 may be formed in a substantially hollow quadrangular shape and may surround edges of the frame 160. In other words, the choke member 170 may be directly exposed to the cavity 11.

FIG. 12 is a perspective view illustrating the outer panel 120 according to an embodiment. FIG. 13 is a view of FIG. 12 in another direction. FIG. 14 is a view illustrating an inner panel and an air guide according to an embodiment. FIG. 15 is an exploded perspective view of FIG. 14.

Referring to FIG. 13, the door 20 may include the speaker 260 and the microphone 270. At least one speaker 260 may be mounted at a side of the outer panel 120. The speaker 260 may generate a voice, an alarm sound, and the like necessary for the operation of the cooking appliance. In addition, the speaker 260 may generate a voice, an alarm sound, and the like for the door 20 including the display 110 to function as the IoT hub.

The microphone 270 may be mounted at a lower portion of the outer panel 120 and may receive a user's voice. The user may input a voice command for manipulating the cooking appliance via the microphone 270. In addition, the microphone 270 may play a part of a role for the door 20 to function as the IoT hub.

In one example, a communication unit for communication may be disposed in the door. Because the door 20 functions as the IoT hub, it is appropriate that the communication unit disposed in the door 20 is equipped to perform various types of wired or wireless communication functions.

The outer panel 120 may include a first through-hole 120c and a second through-hole 120d. The first through-hole 120c may be defined at the side of the outer panel 120. The first through-hole 120c may be defined adjacent to a location where the speaker 260 is disposed. Additionally, the first through-hole 120c may be formed in a mesh shape to allow the speaker 260 to be in communication with the outside and simultaneously to suppress the speaker 260 from being exposed to the outside.

The speaker 260 may be in communication with the outside of the outer panel 120 via the first through-hole 120c, thereby effectively transmitting the alarm and other voices to the user. Because the speaker 260 includes a pair of speakers, the first through-hole 120c may also include a pair of first through-holes defined at locations corresponding to the pair of speakers 260, respectively.

The second through-hole 120d may be defined to extend through the outer panel 120 at a lower portion of one side of the outer panel 120. A portion of the button device 300 mounted inside the outer panel 120 may be exposed to the outside of the outer panel 120 via the second through-hole 120d. The user may manipulate the button device 300 by being in contact with an exposed portion of the outer panel 120.

The outer panel 120 may have the first outlet 123 defined at an upper portion thereof and the second outlet 124 defined at a lower portion thereof. The first outlet 123 may be defined at the upper portion of the outer panel 120, and air flowing inside the door may be discharged to the outside by the blower 150. The second outlet 124 may be defined at the lower portion of the outer panel 120, and air flowing inside the door may be discharged to the outside by the blower 150.

The first outlet 123 may be defined at a location adjacent to an upper end of the display 110, and the second outlet 124 may be defined at a location adjacent to a lower end of the display 110. Accordingly, air forced to flow inside the door 20 by the blower 150 may be discharged to the outside at the locations adjacent to the upper end and the lower end of the display 110 via the first outlet 123 and the second outlet 124.

Air discharged via the first outlet 123 may form the air curtain above the door 20. In addition, air discharged via the second outlet 124 may form the air curtain below the door 20.

The air curtain refers to a means for blocking external air flow from penetrating into the door 20. In an embodiment, a boundary surface or a boundary area where the flow of air discharged from the inside of the door 20 via the first outlet 123 and the second outlet 124 forms a boundary with the external air flow may be referred to as the air curtain.

The air curtains formed by air discharged from the inside of the door 20 via the first outlet 123 and the second outlet 124 may suppress external air from penetrating into the door 20.

Because the heating cooking appliance is disposed below the cooking appliance, heat generated when the heating cooking appliance is used and oil vapor generated from the food being cooked may rise and penetrate the cooking appliance.

Heat transferred from the heating cooking apparatus to the cooking apparatus may damage a component of the door 20 disposed in the cooking apparatus. In particular, the display 110 and a component in which a circuit, a module, or the like related to the operation thereof is embedded may be vulnerable to heat.

In addition, oil vapor delivered from the food being cooked may be adhered to the door 20 disposed in the cooking appliance. Oil vapor may be adhered to a surface of the display 110 and degrade an image quality of the display 110, and may be adhered to a surface of other components mounted on the door 20 to damage such components.

In an embodiment, the air flow discharged to the outside of the door 20 via the first outlet 123 and the second outlet 124 defined in the door 20 may form the air curtains, so that heat and oil vapor rising from the heating cooking appliance disposed below the cooking appliance may be effectively blocked by the air curtains. Additionally, the air flow discharged to the outside of the door 20 via the first outlet 123 and the second outlet 124 may prevent other substances, such as dust, from entering the door 20.

Accordingly, the various electronic components including the display 110 disposed on the door 20 may be effectively suppressed from being damaged or degraded in function by heat, oil vapor and other foreign substances.

Referring to FIG. 14, the air guide 140 may include an inlet 141 and an exhaust port 142. The inlet 141 may be defined at an upper portion of the air guide 140, may allow external air to be introduced thereinto, and may include at least one inlet. In an embodiment, the inlet 141 may include at least two inlets, and each inlet 141 may be located at an end of the air guide 140.

The inlet 141 may be defined at a location corresponding to the first vent hole 121 defined in the upper portion of the outer panel 120. Accordingly, external air may pass through the first vent hole 121 of the outer panel 120 and be introduced into the door 20 via the inlet 141.

The exhaust port 142 may be formed below the inlet 141 in the air guide 140, and the blower fan 152 may be disposed at a location overlapping the exhaust port 142 in the front and rear direction. The exhaust port 142 may be formed to extend through the air guide 140 in the front and rear direction of the door 20.

Accordingly, air may flow from the upper portion to a lower portion of the air guide 140 via the inlet 141, and may flow again via the exhaust port 142 in a changed direction from a rear space to a front space of the air guide 140.

The blower 150 may include a casing 151 and the blower fan 152. The casing 151 may be disposed in the exhaust port 142, may have a hollow defined therein, and may have the blower fan 152 mounted in the hollow. A shape of the exhaust port 142 may correspond to a shape of the casing 151.

The blower fan 152 may be rotatably mounted on the casing 151, and may allow air to flow from the rear space to the front space of the air guide 140. The blower fan 152 may rotate by receiving electricity to allow air to flow inside the door 20.

By the rotation of the blower fan 152, external air may be introduced into the door 20 via the inlet 141 and discharged to the outside of the door 20 via the first outlet 123 and the second outlet 124. The exhaust port 142 of the air guide 140 may be formed at a center of the casing 151 to correspond to a location, an area size, and a shape of the hollow in which the blower fan 152 is disposed.

FIG. 16 is a side cross-sectional view of the door 20 viewed in a direction 16-16 in FIG. 5. Hereinafter, the flow of air inside the door 20 will be described in detail with reference to FIG. 16. In FIG. 16, the flow of air is indicated by arrows.

As the blower fan 152 rotates, external air may flow into the door 20 via the inlet 141 of the air guide 140 and may flow to be discharged to the outside of the door 20 via the first outlet 123 and the second outlet 124.

Air forced to flow by the blower fan 152 may specifically have a flow path as follows. Air may be introduced into the door 20 from the first vent hole 121 of the outer panel 120 and the inlet 141 defined at a location corresponding thereto. Air introduced into the door 20 may flow in a downward direction of the door 20 and may be introduced into the blower fan 152. Air may pass through the blower fan 152 in the front and rear direction of the door 20. In this regard, air may pass through the exhaust port 142 of the air guide 140 while passing through the blower fan 152. The flow direction of air in the blower fan 152 may be changed from the vertical direction of the door 20 to the front and rear direction.

Because a front space of the exhaust port 142 is blocked by the display 110, air that has passed through the exhaust port 142 may be branched in the vertical direction in a space ahead of the air guide 140.

A portion of the branched air may flow in the upward direction of the door 20 and may be discharged to the first outlet 123 (i.e. the air may flow in a “U” shape”). The other portion of the branched air may flow in the downward direction of the door 20 and be discharged to the second outlet 124.

Air branched from the first outlet 123 and the second outlet 124 may surround the entire door 20. The branched air may particularly surround the front surface of the door 20. Because of such a structure, air discharged from the first outlet 123 and the second outlet 124 forms the air curtains on the door 20, thereby effectively suppressing heat and oil vapor generated from the heating cooking appliance disposed below the cooking appliance from penetrating into the door 20. Accordingly, a function of the components included in the door 20 can be improved, because these components are not contaminated by heat and oil vapor.

In addition, because of the above-described air flow structure inside the door 20, air introduced into the door 20 may flow through the entire inside of the door 20. For example, air may flow in an entire space defined by the rear surface of the display 110 and the outer panel 120.

Accordingly, air flowing inside the door 20 may cool the entire rear surface of the display 110 and effectively cool the components mounted on the outer panel 120 and other portions of the door 20.

In particular, the outer panel 120 may be equipped with components that generate heat, such as the speaker 260, the microphone 270, and the printed circuit board. Such heating components may be arranged over the entire outer panel 120. Therefore, air may effectively cool such heating components while flowing through the entire inside of the outer panel 120.

As shown in FIG. 16, the first vent hole 121 through which air is introduced and the inlet 141 may be in communication with each other. As the blower fan 152 rotates, external air may be introduced into the air guide 140 via the first vent hole 121 and the inlet 141 and flow toward the blower 150 via a space defined by the inner panel 130 and the air guide 140.

Air may flow toward the blower fan 152 of the blower 150 in a space defined by the frame 160. Air may pass through the blower fan 152 and hit the rear surface of the display 110 disposed to face the blower fan 152 to cool the display 110.

Air that has passed through the blower fan 152 may hit the rear surface of the display 110, and then the flow thereof may be branched in the upward and downward directions of the display 110. Air directed to an upper side of the display 110 may be discharged to the outside of the door 20 via the first outlet 123 defined at the upper side of the outer panel 120. Air directed to the lower side of the display 110 may be discharged to the outside of the door 20 via the second outlet 124 defined at the lower side of the outer panel 120. Accordingly, because air is branched in both the upward and downward directions of the display 110, the entire display 110 may be cooled by the blown air.

In an embodiment, air flowing inside the door 20 may cool the entire front surface of the display 110 while being discharged via the first outlet 123. In addition, air flowing inside the door 20 may effectively cool the rear surface of the display 110 and the heating components mounted inside the door 20.

The exhaust port 142 may be formed at a center of the air guide 140. The casing 151 may have the hollow having a location, a size, and a shape corresponding to those of the exhaust port 142, and the blower fan 152 may be disposed in the hollow. The casing 151 may be disposed to be located at a location where the hollow thereof and the exhaust port 142 of the air guide 140 correspond to each other, and may be mounted on one surface of the air guide 140.

A hollow 130a may be defined in the inner panel 130. Because the hollow 130a of the inner panel 130 is closed by the frame 160, air introduced via the inlet 141 may not leak into the hollow 130a of the inner panel 130. Accordingly, the inner panel 130 and the frame 160 may form together an air flow path through which air that cools the inside of the door 20 flows.

FIG. 17 is an enlarged view of a portion 17 in FIG. 16. The door 20 may include a front coupling portion 24 disposed upward of the display 110, protruding forwardly of the door 20, and coupled to the outer panel 120. A gap having a predetermined size may be formed between a lower portion of the front coupling portion 24 and the front surface of the display 110, and such a gap may serve as a discharge path for air that cools the inside of the door 20.

The front coupling portion 24 may include a sensing module 310 and a panel 320. The sensing module 310 may be disposed upward and forward of the display module 21, may sense an external situation, and may include various types of sensing devices. However, the present disclosure is not limited thereto. In another embodiment, the sensing module 310 may be disposed equal to or rearward of the display module 21.

In addition, the door 20 may include an outlet through which air flowing inside the door 20 is discharged. The outlet may include a first outlet 123 and a second outlet 124. The first outlet 123 may be defined at the upper portion of the door 20 and may overlap with the panel 320 in the front and rear direction. The second outlet 124 may be defined at the lower portion of the door 20. In this regard, the panel 320 may cover the first outlet 123 from the front.

The panel 320 may be disposed upward and forward of the display module 21. The panel 320 may cover the sensing module 310. Because the panel 320 covers the sensing module 310, the panel 320 may form an outer shape of the front coupling portion 24. In this regard, the sensing module 310 may be accommodated in the panel 320.

In another embodiment, the sensing module 310 may not be accommodated in the panel 320, but may be disposed at the rear of the panel 320. In another embodiment, the sensing module 310 may be mounted on another portion of the door 20, for example, on the outer panel 120 that forms an outer appearance of the door 20.

The panel 320 may be disposed to overlap the display module 21. However, in another embodiment, the panel 320 may be disposed above the display module 21 without overlapping the display module 21.

The panel 320 may protrude forward of the display module 21. In another embodiment, the panel 320 may not protrude with respect to the display module 21, and may be disposed such that a front surface thereof is on the same plane as a front surface of the display module 21 or lies rearward of the front surface of the display module 21.

The panel 320 may be disposed such that a longitudinal direction thereof is directed in the lateral direction of the door 20, and may be formed in an overall long rod shape. The panel 320 may guide the flow direction of air discharged from the first outlet 123. For example, the panel 320 may change the flow direction of air discharged from the first outlet 123 to the downward direction. Accordingly, air may flow downward after entering the first vent hole 121, then be blown in a horizontal direction by the blower fan 152, then flow upwards toward the first outlet 123, and then be redirected downward by the panel 320. Therefore, a direction of air entering the first vent hole 121 and a direction of air exiting the panel 320 may be a same direction.

To this end, the panel 320 may be disposed in front of the first outlet 123. The panel 320 may be disposed to overlap the first outlet 123 in the front and rear direction. Air flowing inside the door 20 may be discharged in the forward direction of the door 20 via the first outlet 123 located at the upper portion of the door 20.

In this regard, the panel 320 may block the first outlet 123 from the front, and air discharged from the first outlet may be blocked by the panel 320 and the flow direction thereof may be changed from the forward direction to the downward direction of the door 20.

In addition, a lower end of the panel 320 may protrude further downward than a lower end of the first outlet 123. Because of such a structure, air discharged from the first outlet 123 may collide with the panel 320 and may be guided by the panel 320, so that the flow path thereof may be changed to the downward direction.

Air discharged from the first outlet 123 in the forward direction may flow in the downward direction by the panel 320. Air discharged in the forward direction from the first outlet 123 may collide with a rear surface of the panel 320 and flow in a changed direction toward an open lower portion between the panel 320 and the first outlet 123. In addition, because the lower end of the panel 320 further protrudes in the downward direction than the lower end of the first outlet 123, air may be guided by the lower end of the panel 320 to flow, and then may continue to flow in the downward direction of the door 20 for a certain period of time after exiting the door 20.

Air forced to flow by the blower fan 152 may be introduced from the inlet 141, flow in the downward direction of the door 20, be introduced into the blower fan 152, pass the blower fan 152 in the front and rear direction of the door 20, and diverge in the vertical direction at a location in front of the air guide 140. Further, a portion of air may flow in the upward direction of the door 20 and be discharged to the first outlet 123, and the rest of air may flow in the downward direction of the door 20 and be discharged to the second outlet 124.

In this regard, air discharged from the first outlet 123 may be guided by the panel 320 to flow downward, and at least a portion thereof may come into contact with the front surface of the display 110. In addition, at least a portion of air discharged from the second outlet 124 may flow forward of the door 20.

Air discharged from the second outlet 124 may flow forward of the door 20, and thus may serve as the air curtain that blocks oil vapor and other foreign substances rising from the heating cooking appliance below the cooking appliance from being adhered to the front surface of the display 110. Specifically, the air discharged from the second outlet 124 may form the air curtain over a lower portion of the display 110.

Air discharged from the first outlet 123 may form the air curtain like air discharged from the second outlet 124 to prevent oil vapor or the like from being adhered to the front surface of the display 110. Specifically, the air discharged from the first outlet 123 may form the air curtain over an upper portion of the display 110.

In addition, air discharged from the first outlet 123 may be changed in the flow direction by the panel 320 and discharged in the downward direction of the door 20, so that at least a portion thereof may come into contact with the front surface of the display 110. Accordingly, the panel 320 may guide the flow direction of air discharged from the first outlet 123.

An edge of the display 110 may include a bezel 110b formed as an opaque area to cover the internal components of the display 110. Referring to FIG. 17, the panel 320 may be disposed to at least partially overlap the bezel 110b formed at the edge of the display 110 in the front and rear direction.

In this regard, the panel 320 may be disposed to protrude further forward than the display 110 and may be disposed to be spaced apart from the display 110 in the front and rear direction. Specifically, a rear surface 321-1 of a coupling panel 321 of the panel 320 may be disposed to protrude further forward than a front surface 110a of the display 110.

A space may be defined between the rear surface 321-1 of the coupling panel 321 and the front surface 110a of the display 110, and such a space may become a passage through which air flowing inside the door 20 is discharged to the outside of the door 20, as shown by an arrow in FIG. 17.

Air that has passed through the first outlet 123 may hit the rear surface 321-1 of the coupling panel 321 and flow by changing the flow direction thereof to the downward direction. Accordingly, air that has passed through the first outlet 123 may not be discharged directly forward of the door 20, but may be discharged to the outside of the door 20 after cooling the display 110 again by directly coming into contact with the front surface 110a of the display 110.

Because of such a structure, air discharged from the first outlet 123 may directly come into contact with the front surface of the display 110 to cool the front surface of the display 110. Therefore, the front surface and the rear surface of the display 110 are both cooled by air, so that cooling efficiency may be significantly improved compared to a case in which only the rear surface of the display 110 is cooled.

Next, FIG. 18 is a perspective view illustrating the front coupling portion 24 according to an embodiment. FIG. 19 is a view of FIG. 18 in another direction. FIG. 20 is an exploded perspective view of FIG. 18.

The front coupling portion 24 may include the sensing module 310 and the panel portion 320. The sensing module 310 may be disposed at the rear of the panel 320. The sensing module 310 may be accommodated in the panel 320. The sensing module 310 may include at least one of a first camera 311 and a sensing board 312. As described above, the first camera 311 may film the space ahead of the cooking appliance.

The sensing board 312 may be disposed to be spaced apart from the first camera 311, and may have a sensor that recognizes an external situation mounted thereon. The sensing board 312 may have a form in which the sensor is mounted on a printed circuit board. The sensor mounted on the sensing board 312 may include at least one of an illuminance sensor 3121 and a human sensor 3122. In addition, the sensing board 312 may have a longer length extending in a length direction of the first coupling portion 24 than a length extending in a width direction of the first coupling portion 24.

The illuminance sensor 3121 may sense external illuminance. The illuminance sensor 3121 may sense brightness of light and transmit the brightness to a controller that controls the operation of the cooking appliance. The controller may appropriately adjust brightness of the lighting unit 25, based on the information on the ambient light brightness transmitted from the illuminance sensor 3121. The controller may control various operations of the cooking appliance based on the information on the sensed ambient light brightness.

The human sensor 3122 may sense a presence of the user in front of the cooking appliance. The human sensor 3122 may sense whether there is a person in front of the door 20 via, for example, infrared recognition or motion recognition. The controller disposed in the cooking appliance may identify whether there is the user in front of the cooking appliance via the human sensor 3122.

When there is the user, the controller may activate a function of the cooking appliance necessary for convenience and safety of the user, for example, by operating the display 110 such that the user may immediately use the display 110.

In an embodiment, the cooking appliance may include, as a sensing device, at least one of the first camera 311 that films the space ahead, the illuminance sensor 3121 that senses the ambient illuminance, and the human sensor 3122 that senses the presence of the user ahead.

Such sensing devices may enable the user to have a video meeting with another person at a remote location via the cooking device. In addition, the sensing devices may control the brightness of the lighting of the cooking appliance based on the ambient illuminance. In addition, the sensing devices may provide convenience beyond simple cooking to the user, such as sensing the presence of the user and performing a required operation.

The panel 320 may be composed of at least one of the coupling panel 321 and a cover panel 322. In addition, the panel 320 may include a cover window 323. The coupling panel 321 may be disposed such that a longitudinal direction thereof is directed in the lateral direction of the door 20. In addition, the first camera 311 and the sensing board 312 may be disposed on the coupling panel 321.

A protruding structure for coupling the first camera 311 with the sensing board 312 may be disposed on the coupling panel 321. In addition, the coupling panel 321 may also include a protruding structure for coupling to the upper portion of the outer panel 120.

Therefore, because the coupling panel 321 has a somewhat complex three-dimensional structure, it may be, for example, manufactured via injection molding using a plastic material that has a good moldability and facilitates the manufacturing.

The cover panel 322 may be formed in a shape corresponding to the coupling panel 321 and may be disposed to cover at least a portion of the coupling panel 321. The cover panel 322 assembled to the door 20 may form outer shapes of the front coupling portion 24 and the panel portion 320 as a whole.

Because the cover panel 322 accommodates and covers the coupling panel 321, it may be manufactured by molding a generally thin plate. For example, the cover panel 322 may be manufactured by three-dimensionally molding a metal plate made of aluminum or stainless steel.

The cover window 323 may be disposed at a front portion of the panel 320. The cover window 323 may be disposed inside the cover panel 322. The cover window 323 may cover the first camera 311, the illuminance sensor 3121, and the human sensor 3122 from the front. Additionally, the cover window 323 may be located at a central portion of the coupling panel 321 and the cover panel 322. However, the present disclosure is not limited thereto.

The cover window 323 may be disposed in front of the first camera 311, the illuminance sensor 3121, and the human sensor 3122 and prevent them from being exposed to the outside, thereby protecting them. The cover window 323 may be made of a transparent material such that the first camera 311 films an image of a clear image quality and the human sensor 3122 clearly identifies the user.

In one example, in another embodiment, the cover window 323 may be divided into separate portions, respectively for protecting the first camera 311, for protecting the illuminance sensor 3121, and for protecting the human sensor 3122.

The coupling panel 321 may include a reinforcing rib 3210. The reinforcing rib 3210 may protrude from a rear surface of the coupling panel 321 to reinforce and increase rigidity of the coupling panel 321. The reinforcing rib 3210 may be formed to be directed in a direction in which a longitudinal direction thereof intersects a longitudinal direction of the coupling panel 321, and may include a plurality of reinforcing ribs spaced apart from each other in the longitudinal direction of the coupling panel 321.

The coupling panel 321 may include a plurality of holes for mounting the camera and the sensing devices. To this end, the coupling panel 321 may include a first through-hole 3211, a second through-hole 3212, and a third through-hole 3212.

The first through-hole 3211 may be defined at a location corresponding to the first camera 311 and expose a front filming portion of the first camera 311 forward of the coupling panel 321, so that the first camera 311 may film the object and the user in front of the door 20.

The second through-hole 3212 may be defined to be spaced apart from the first through-hole 3211 in the lateral direction, and may be defined at a location corresponding to the illuminance sensor 3121. The second through-hole 3212 may expose the illuminance sensor 3121 forward of the coupling panel 321, so that the illuminance sensor 3121 may sense illuminance of the space ahead of the door 20.

The third through-hole 3213 may be defined to be spaced apart from the second through-hole 3212 in the lateral direction, and may be defined at a location corresponding to the human sensor 3122. The third through-hole 3213 may expose a front portion of the human sensor 3122 forward of the coupling panel 321, so that the human sensor 3122 may sense the user located in front of the door 20. Therefore, each of the first through-hole 3211, second through-hole 3212 and third through-hole 3213 may be spaced out along the coupling panel 321.

The coupling panel 321 may include a window seating groove 3214 that is formed by recessing a front surface of the coupling panel 321, is formed in an area overlapping the first through-hole 3211, the second through-hole 3212, and the third through-hole 3213, and allows the cover window 323 to be seated therein. The window seating groove 3214 may be defined by recessing the front surface of the coupling panel 321 and may be formed in a shape corresponding to the cover window 323.

The cover panel 322 and the coupling panel 321 may be coupled to each other in a state in which the cover window 323 is seated in the window seating groove. As the cover window 323 is disposed in the window seating groove, the cover panel 322 and the coupling panel 321 may be brought into close contact with each other even though the cover window 323 has a predetermined thickness, and thus the panel 320 may become generally slim.

The cover panel 322 may include a front surface 3221 and a side portion 3222. The front surface 3221 may cover the front surface of the coupling panel 321. The side portion 3222 may be formed by being bent from the front surface 3221 at an edge of the front surface 3221. The side portion 3222 may include a pair of side portions formed at both sides of the front surface 3221, respectively.

The front surface 3221 may include a fourth through-hole 3223 defined at a location corresponding to the window seating groove 3214.

The fourth through-hole 3223 may be defined in an area overlapping the first through-hole 3211, the second through-hole 3212, and the third through-hole 3213. Accordingly, the first camera 311, the illuminance sensor 3121, and the human sensor 3122 may film the object and the user in the area ahead of the cover panel 322, sense the illuminance, and sense the presence of the user via the fourth through-hole 3223.

The fourth through-hole 3223 may be formed with an area size smaller than an area size of the cover window 323. Accordingly, the cover window 323 may maintain the state of being stably coupled to the panel 320 without being deviated to the outside of the panel 320 via the fourth through-hole 3223.

FIG. 21 is a plan view illustrating a portion of the cover panel 322 according to an embodiment. FIG. 22 is a side view of FIG. 21.

The cover panel 322 may include an upper bent portion 3224 and a bent coupling portion 3225. The upper bent portion 3224 may be formed by being bent from an upper end of the front portion 3221. The upper bent portion 3224 may cover an upper portion of the coupling panel 321.

The bent coupling portion 3225 may extend from at least one of the side portion 3222 and the upper bent portion 3224, and may be bent to couple the cover panel 322 with the coupling panel 321. The bent coupling portion 3225 may be bent to be coupled to the coupling panel 321, and accordingly, the cover panel 322 and the coupling panel 321 may be firmly coupled to each other.

Because the cover panel 322 is made of a metal material, when the bent coupling portion 3225 is bent, plastic deformation may occur to maintain the bent state, thereby maintaining the state in which the cover panel 322 and the coupling panel 321 are coupled to each other.

The bent coupling portion 3225 may include a first sub-coupling portion 3225a and a second sub-coupling portion 3225b. The first sub-coupling portion 3225a may be formed on at least one of the side portion 3222 and the upper bent portion 3224, and may be bent to be coupled to the coupling panel 321.

At least one first sub-coupling portion 3225a may be formed on the side portion 3222 at one side. In addition, the first sub-coupling portion 3225a may include a plurality of first sub-coupling disposed at locations spaced apart from each other on the upper bent portion 3224, and the plurality of first sub-coupling portions 3225a may be aligned at a spacing in a longitudinal direction of the cover panel 322.

The first sub-coupling portion 3225a may be bent to be coupled to the coupling panel 321. Because the first sub-coupling portion 3225a is coupled to the coupling panel 321 only by the bending, the plurality of the first sub-coupling portions 3225a may be formed on the cover panel 322 to stably couple the cover panel 322 with the coupling panel 321. The first sub-coupling portion 3225a may generally be formed to be thin and long and have a small thickness to facilitate the bending.

The second sub-coupling portion 3225b may be formed on the side portion 3222, and may be bent to define a screw fastening hole 25b1 defined to correspond to a screw fastening boss 321e formed on the coupling panel 321. The second sub-coupling portion 3225b may be firmly coupled to the coupling panel 321 by a coupling mechanism such as a screw or the like.

Because, as the first sub-coupling portion 3225a is coupled to the coupling panel 321 only by the bending, a coupling strength may be low, the second sub-coupling portion 3225b may be fixed to the coupling panel 321 by the coupling mechanism to compensate therefor, thereby firmly coupling the coupling panel 321 and the cover panel 322 to each other as a whole. In addition, a length of the second sub-coupling portion 3225b may be longer than a length of the first sub-coupling portion 3225a.

FIG. 23 is a view for illustrating a coupling structure of the second sub-coupling portion 3225b. The second sub-coupling portion 3225b may include a second sub-bent portion 25b2 and a fastening hole defining portion 25b3. In an embodiment a maximum length and a maximum width of the fastening hole defining portion 25b3 may be greater than a maximum length and a maximum width of the second sub-bent portion 25b2.

The second sub-bent portion 25b2 may be bent when the cover panel 322 and the coupling panel 321 are coupled to each other. The second sub-bent portion 25b2 may generally be formed to be thin and long and have a small thickness to facilitate the bending.

When the second sub-bent portion 25b2 is bent, the fastening hole forming portion 25b3 may be disposed at a location corresponding to the screw fastening boss 321e, and the screw fastening hole 25b1 may be defined.

When the second sub-bent portion 25b2 is bent for the coupling, the screw fastening hole 25b1 may be defined at a location corresponding to a hole of the screw fastening boss 321e. Accordingly, the fastening hole forming portion 25b3 and the screw fastening boss 321e may be fastened to each other by a coupling mechanism, for example, a grounding screw 1100, so that the coupling panel 321 and the cover panel 322 may be firmly coupled to each other.

In one example, a guide groove 3215 that guides seating of the bent portion of the bent coupling portion 3225 may be defined in the coupling panel 321 at a location where the bent coupling portion 3225 is coupled. The guide groove 3215 may be defined at locations corresponding to the first sub-coupling portion 3225a and the second sub-coupling portion 3225b of the bent coupling portion 3225, respectively.

The guide groove 3215 may be defined by recessing ends of the coupling panel 321 at the locations corresponding to the first sub-coupling portion 3225a and the second sub-coupling portion 3225b, respectively. Because the first sub-coupling portion 3225a and the second sub-coupling portion 3225b are guided and bent by the guide grooves 3215, an occurrence of an assembly defect resulted from incorrect bending may be effectively suppressed.

The cover panel 322 made of the metal material may be grounded. The second sub-coupling portion 3225b disposed on the cover panel 322 may be electrically connected to a grounding cable 740, and accordingly, the cover panel 322 may be grounded. The grounding cable 740 may be disposed to improve an operating performance of the cooking appliance by grounding electricity leaking from the door 20. The grounding cable 740 may be disposed in the main body 10 and electrically connected to a control module that controls the operation of the cooking appliance.

A grounding terminal 742 in which a hole is defined may be disposed at an end of the grounding cable 740. The grounding terminal 742 may be disposed at a location corresponding to the screw fastening hole 25b1. The grounding screw 1100 may be disposed to couple the grounding terminal 742 to the second sub-coupling portion 3225b. Specifically, the grounding terminal 742 may be located between the screw fastening hole 25b1 and a head of the grounding screw 1100.

The grounding screw 1100 may extend through the hole of the grounding terminal 742 and the screw fastening hole 25b1 of the sub-coupling portion 3225b to be screwed to the screw fastening boss 321e. Accordingly, the grounding terminal 742 may be fastened to the cover panel 322 and come into contact with the sub-coupling portion 3225b.

When the sub-coupling portion 3225b made of the metal material and the grounding terminal 742 are coupled to each other, the cover panel 322 may be electrically connected to the control module of the main body 10, and accordingly, the front coupling portion 24 including the cover panel 322 may be grounded.

FIG. 24 is a diagram for illustrating a coupling structure of the first sub-coupling portion 3225a. The first sub-coupling portion 3225a may be bent to be plastically deformed, and may come into contact with the end of the coupling panel 321 in that state to maintain the state of being coupled with the coupling panel 321.

Unlike the second sub-coupling portion 3225b, the first sub-coupling portion 3225a is not screw-coupled, so that the first sub-coupling portion 3225a may include a plurality of first sub-coupling portions to increase a coupling strength, and the plurality of first sub-coupling portions 3225a may be formed to protrude from a lower portion of the cover panel 322, the side portion 3222, and the upper bent portion 3224, respectively.

In an embodiment, as the first sub-coupling portion 3225a and the second sub-coupling portion 3225b formed to protrude from the cover panel 322 are bent or coupled to the coupling panel 321 by the coupling mechanism, the cover panel 322 and the coupling panel 321 may be firmly coupled to each other.

Because of such a structure, the number of screw fastening structures for coupling the cover panel 322 and the coupling panel 321 having relatively great area sizes to each other may be significantly reduced to improve ease of assembly of the components, and the number of necessary fastening mechanisms may be reduced to improve external aesthetics of the cooking appliance.

FIG. 25 is a diagram for illustrating a coupling structure between the first camera 311, the sensing board 312, and the coupling panel 321. FIG. 26 is a front view illustrating a portion of the coupling panel 321 according to an embodiment. FIG. 27 is a perspective view illustrating a state in which the first camera 311 and the sensing board 312 are coupled to the coupling panel 321.

The coupling panel 321 may include a first holder 3216 protruding rearward from a rear surface, formed to surround the third through-hole 3213, and on which the human sensor 3122 is mounted. The human sensor 3122 may be formed in a cylindrical shape as a whole and may have a predetermined volume. However, the present disclosure is not limited thereto. The human sensor 3122 may be formed in other shapes such as rectangular or triangular.

To mount such a human sensor 3122 on the coupling panel 321, the first holder 3216 allows the cylindrical human sensor 3122 to be seated on the coupling panel 321. The first holder 3216 will be described in more detail below.

The coupling panel 321 may include a light guide 321d at a location corresponding to the illuminance sensor 3121. The light guide 321d may be formed to protrude from the rear surface of the coupling panel 321, and may be formed in a cone shape in which a cross-sectional area increases in the forward direction.

Accordingly, a cone-shaped space may be defined inside the light guide 321d, light around the cooking appliance may be guided by the light guide to reach the illuminance sensor 3121, and the illuminance sensor 3121 may sense the external illuminance.

As described above, the sensing module 310 may include the sensing board 312 having the front surface on which the illuminance sensor 3121 and the human sensor 3122 are mounted. To couple the sensing board 312 to the coupling panel 321, the coupling panel 321 may include a first fastening protrusion 3217 and a first mounting protrusion 3218.

The first fastening protrusion 3217 may protrude rearward from the rear surface of the coupling panel 321 and may be fastened to the sensing board 312 by a coupling mechanism. The sensing board 312 may have a hole defined therein to which the coupling mechanism is coupled, at a location corresponding to the first coupling protrusion 3217.

The first mounting protrusion 3218 may protrude rearward from the rear surface of the coupling panel 321, may be disposed at a location spaced apart from the first fastening protrusion 3217, and may have an end of the sensing board 312 mounted thereon. One end of the sensing board 312 may be coupled to the first fastening protrusion 3217, and the other end thereof may be mounted on the first mounting protrusion 3218 without a coupling mechanism. Specifically, the sensing board 312 may include a screw that screws into the first fastening protrusion 3217.

The first camera 311 may include a camera body 3111 and a camera board 3112. The first camera 311 may be disposed in the first through-hole 3211 and may film a subject. The camera body 3111 may have at least one lens disposed, may film the object or the person, and may be formed in a cylindrical shape as a whole.

The camera body 3111 may be mounted on the camera board 3112. The camera board 3112 may include a control device for controlling an operation of the camera body 3111, and may be electrically connected to the controller of the cooking appliance to transmit the filmed image and video to the controller. The camera board 3112 may have a thicker width at a portion connected to the camera body 3111 than a width at a portion not connected to the camera body 3111.

The first camera 311 may be mounted on and coupled to the coupling panel 321 as the camera board 3112 is coupled to and supported by the coupling panel 321. To mount and couple the camera board 3112, the coupling panel 321 may include a first sub-support protrusion 3218b, a second fastening protrusion 3219, and a second sub-support protrusion 321a.

The first sub-support protrusion 3218b may be disposed in the first mounting protrusion 3218. The first sub-support protrusion 3218b may protrude from an opposite surface of a surface of the first mounting protrusion 3218 on which a first sub-mounting protrusion 3218a is formed, and may support the camera board 3112.

The second fastening protrusion 3219 may protrude rearward from the rear surface of the coupling panel 321, may be disposed at a location spaced apart from the first mounting protrusion 3218, and may be fastened to the camera board 3112 by a coupling mechanism.

The second sub-support protrusion 321a may protrude rearward from the rear surface of the coupling panel 321, may support a corner of the camera board 3112, and may have a bent portion. The second fastening protrusion 3219 and the second sub-support protrusion 321a may be integrally formed. However, in another embodiment, the second fastening protrusion 3219 may be a screw that screws into the second sub-support protrusion 321a.

One end of the camera board 3112 may be coupled to the coupling panel 321 by the second fastening protrusion 3219 and a coupling mechanism. The other end of the camera board 3112 may be mounted on the first sub-support protrusion 3218b.

The second fastening protrusion 3219 may support a bottom surface of the camera board 3112. A top surface of the second fastening protrusion 3219 and the bottom surface of the camera board 3112 may be in contact with each other. As such, the second fastening protrusion 3219 may support the camera board 3112 such that the camera board 3112 and the camera body 3111 are maintained at locations designed in the front and rear direction on the coupling panel 321.

For the camera board 3112 to maintain the location thereof so as not to deviate from the designed location while being mounted on the coupling panel 321, the second sub-support protrusion 321a may be disposed on the coupling panel 321. The second sub-support protrusion 321a may support a side surface of the camera board 3112 in one direction and a direction intersecting the one direction to suppress the movement of the first camera 311.

That is, the second sub-support protrusion 321a may be formed in a shape bent in a longitudinal direction of the coupling panel 321 and a direction intersecting the longitudinal direction. Such a bent second sub-support protrusion 321a may support the bent corner of the camera board 3112 in one direction and a direction intersecting the same, thereby suppressing the camera board 3112 from moving on a plane intersecting the front and rear direction of the coupling panel 321.

Because of such a structure, the first camera 311 may be stably remained at the designed location in the state of being coupled to the coupling panel 321.

The first holder 3216 may be formed in a protruding shape with two stages, and accordingly, may include a base protruding portion 3216a and an additional protruding portion 3216b. The base protruding portion 3216a may protrude from the coupling panel 321 and may be formed in a circumferential shape. A portion of the human sensor 3122 may be accommodated in an inner space of the base protruding portion 3216a.

The additional protruding portion 3216b may be formed to further protrude from a portion of the base protruding portion 3216a and formed in an arcuate shape. Because the additional protruding portion 3216b is formed by extending the portion of the base protruding portion 3216a formed in the circumferential shape, it may be formed in the arcuate shape. However, the present disclosure is not limited thereto.

A step may be formed between the base protruding portion 3216a and the additional protruding portion 3216b, and a space of such a step may be used as a space in which the cylindrical human sensor 3122 protruding forward avoids the first holder 3216 when the sensing board 312 is assembled to the coupling panel 321. This will be described in more detail with reference to following drawings.

FIGS. 28, 29, and 30 are diagrams for illustrating a process of assembling the sensing board 312 and the coupling panel 321.

The first mounting protrusion 3218 may include the first sub-mounting protrusion 3218a protruding toward the first holder 3216 and allowing an end of the sensing board 312 to be mounted therein to restrict a movement thereof. One end of the sensing board 312 may be fitted into the first sub-mounting protrusion 3218a. The end of the sensing board 312 located closer to the illuminance sensor 3121 than the human sensor 3122 may be located in the first sub-mounting protrusion 3218a. However, the present disclosure is not limited thereto.

First, one end of the sensing board 312 may be inserted into the first sub-mounting protrusion 3218a and then the other end of the sensing board 312 may be coupled to a third fastening protrusion 321c to assemble the sensing board 312 to the coupling panel 321.

When the sensing board 312 is assembled to the coupling panel 321 in this order, because the illuminance sensor 3121 disposed on the sensing board 312 has the predetermined volume, the illuminance sensor 3121 may collide with the first holder 3216, so that it is necessary to have a structure in which the illuminance sensor 3121 and the first holder 3216 avoid each other.

To this end, the first holder 3216 may be formed in the two-stage structure including the base protruding portion 3216a and the additional protruding portion 3216b, and the additional protruding portion 3216b may be formed in the arcuate shape to provide a space in which the illuminance sensor 3121 may avoid the first holder 3216.

The additional protruding portion 3216b may be formed as a portion of the circumferential portion forming the base protruding portion 3216a facing the first sub-mounting protrusion 3218a further protrudes from the base protruding portion 3216a.

Hereinafter, a process in which the sensing module 310 including the sensing board 312 is coupled to the coupling panel 321 will be described. First, as illustrated in FIG. 28, one end of the sensing board 312 may be mounted in the first sub-mounting protrusion 3218a in a state in which the sensing module 310 is inclined. Specifically, the one end of the sensing board 312 may enter a slot in the first sub-mounting protrusion 3218a to secure the one end of the sensing board 312.

Thereafter, as illustrated in FIG. 29, the human sensor 3122 may pass through a portion of the base protruding portion 3216b in which the additional protruding portion 3216a is not formed and avoid the additional protruding portion 3216b, thereby being mounted on the first holder 3216.

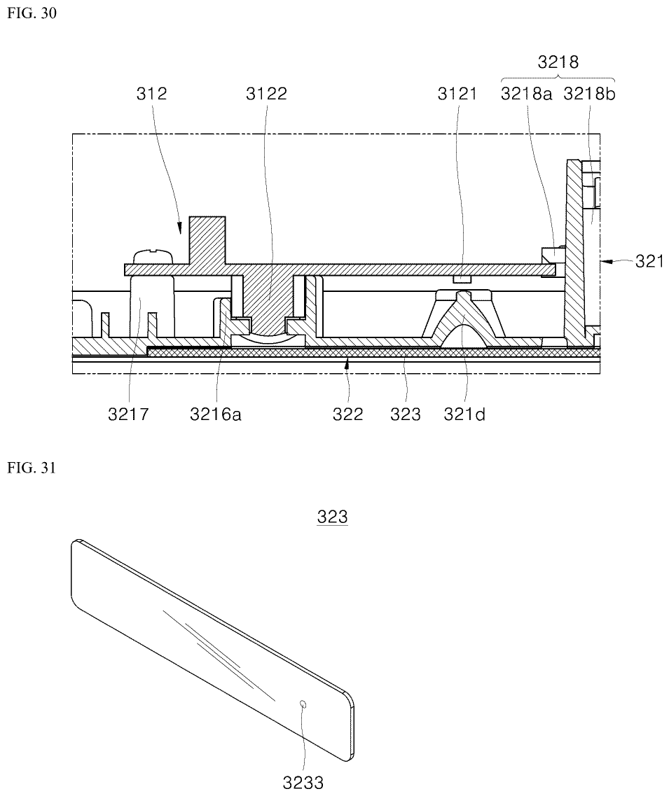

Thereafter, as illustrated in FIG. 30, a portion of a front surface of the sensing board 312 may be in contact with a top surface of the additional protruding portion 3216b, and the other end of the sensing board 312 may be fastened to the first fastening protrusion 3217 through a screw, fastener, or other means of coupling the sensing board 312 to the first fastening protrusion 3217.

In an embodiment, the first holder 3216 may have the two-stage protruding structure including the base protruding portion 3216a and the additional protruding portion 3216b, and the space for avoiding the illuminance sensor 3121 and the first holder 3216 from colliding with each other may be defined at the step formed by the base protruding portion 3216a and the additional protruding portion 3216b.

Because of such a structure, the sensing module 310 may be easily assembled to the coupling panel 321, and ease of assembly of the entire cooking appliance may be improved, thereby saving an assembly time.

Next, FIG. 31 is a perspective view illustrating the cover window 323 according to an embodiment. The cover window 323 may include an exposure hole 3233 that is defined at a location corresponding to the human sensor 3122 and exposes a portion of a front surface 3221 of the human sensor 3122 to the outside.

The human sensor 3122 may sense whether the user is present in front of the door 20 by sensing a user's movement and/or a user's body temperature. In particular, to sense the user's body temperature, the human sensor 3122 may sense infrared light irradiated from the user.

When a front side of the human sensor 3122 is blocked by the cover window 323, at least a portion of the infrared light emitted from the user may not pass through the cover window 323. In this case, the human sensor 3122 may not accurately sense the user.

Accordingly, in an embodiment, the exposure hole 3233 is defined in the cover window 323 to open the front side of the human sensor 3122 and expose the same to the outside, so that the infrared light irradiated from the user passes through the cover window 323 without being blocked by the same and comes into contact with the human sensor 3122, thereby improving an operating performance of the human sensor 3122.

The exposure hole 3233 may be defined at a location overlapping the third through-hole 3213. Accordingly, the exposure hole 3233 may be defined at a location corresponding to the human sensor 3122 disposed in the third through-hole 3213 in the front and rear direction of the cooking appliance, and the human sensor 3122 may sense the user located in front of the cooking appliance by sensing ultraviolet light incident through the third through-hole 3213.

An area size of the exposure hole 3233 may be smaller than an area size of the human sensor 3122. The cover window 323 needs to close the front side of the human sensor 3122 to suppress the human sensor 3122 from being exposed to the outside and protect the same.

Accordingly, the area size of the exposure hole 3233 may be smaller than the area size of the human sensor 3122 to minimize a size of an area in which the front side of the human sensor 3122 is exposed to the outside, so that the cover window 323 may effectively protect the human sensor 3122.

The cover window 323 in an embodiment may have the front surface formed as a flat surface, so that at least a portion thereof may be in contact with an inner surface of the front surface 3221 of the cover panel 322.

The cover window 323 having such a structure may be easily manufactured because of a simple shape. In addition, because it is not necessary to perform complex injection molding for the manufacturing, it may be manufactured using various materials.

For example, the cover window 323 having the front surface 3221 formed as the flat surface illustrated in FIG. 31 may be easily manufactured using a glass material, a plastic material, or various other transparent materials that allows the human sensor 3122 to emit the infrared light to an outside.

However, when the front surface of the cover window 323 is in contact with the inner surface of the front surface 3221 of the cover panel 322, a step may occur between a circumference of the fourth through-hole 3223 and the front surface of the cover window 323 because of a thickness of the front surface 3221 of the cover panel 322.

Such a step may degrade aesthetics, and when the cooking appliance is continuously used, foreign substances may accumulate in the step and the step may look unclean. To solve such a shortcoming, a structure that may reduce the occurrence of the step is needed. This will be described.

FIG. 32 is an exploded perspective view illustrating the cover window 323 and the cover panel 322 according to another embodiment. FIG. 33 is a perspective view illustrating a coupled state of the cover window 323 and the cover panel 322 in FIG. 32.

The cover window 323 illustrated in FIG. 32 may include a protruding body 3232 to reduce the step of the cover window 323 with respect to the fourth through-hole 3223 in the above-described embodiment. That is, the cover window 323 may be formed to include a base body 3231 and the protruding body 3232. The base body 3231 may have a front surface formed as a flat surface, and may be disposed to overlap the front surface 3221 of the cover panel 322.

The protruding body 3232 may protrude forward from the base body 3231, may be formed in a shape corresponding to the fourth through-hole 3223, and may be fitted into the fourth through-hole 3223 to reduce a size of the step between the cover panel 322 and the cover window 323. The protruding body 3232 may be entirely surrounded by the base body 3231 at an outer portion of the protruding body 3232.

When the protruding body 3232 is fitted into the fourth through-hole 3223, the protruding body 3232 may be on the same plane as a front surface of the front surface 3221 of the cover panel 322, or may protrude further than the front surface of the front surface 3221.

Because of such a structure, compared to the cover window 323 illustrated in FIG. 31, the cover window 323 illustrated in FIG. 32 may eliminate the step between the cover panel 322 and the cover window 323 or reduce the size thereof.

Therefore, the aesthetics of the outer appearance of the cooking appliance may be increased, and the foreign substances may be effectively suppressed from being accumulated at the step.

However, because the cover window 323 illustrated in FIG. 32 has the protruding body 3232 protruding from the front surface thereof, it is necessary to be manufactured via the injection molding to form such a structure. Accordingly, the cover window 323 may be made of a plastic material suitable for the injection molding. More specifically, the cover window 323 illustrated in FIG. 32 may be made of, for example, a polymethyl methacrylate (PMMA) material having good moldability and high impact resistance. However, the present disclosure is not limited to PMMA. Other materials having good moldability and high impact resistance may be used

FIG. 34 is an enlarged view of a portion 34 in FIG. 12. FIG. 35 is an enlarged view of a portion 35 in FIG. 12.

The coupling panel 321 may be coupled to a front upper portion of the outer panel 120. As the coupling panel 321 is coupled to the outer panel 120, the entire front coupling portion 24 including the coupling panel 321 may be coupled to the outer panel 120.

To couple the coupling panel 321 to the outer panel 120, the coupling panel 321 may include a panel hook 321b and the third fastening protrusion 321c. The panel hook 321b may protrude rearward from the rear surface of the coupling panel 321 and may include a plurality of panel hooks spaced apart from each other in a longitudinal direction of the coupling panel 321.

In one example, the outer panel 120 may include an outer hook coupling hole 125 defined at a location corresponding to the panel hook 321b and into which the panel hook 321b is inserted and coupled. The outer hook coupling hole 125 may include a plurality of outer hook coupling holes.

However, the number of outer hook coupling holes 125 may be smaller than the number of panel hooks 321b. Some of the panel hooks 321b may be mounted on a separation wall that separates the plurality of first outlets 123 from each other.

The third fastening protrusion 321c may protrude rearward from the rear surface of the coupling panel 321, may include a plurality of third fastening protrusions spaced apart from each other in the longitudinal direction of the coupling panel 321, and may be coupled to the outer panel 120 by a coupling mechanism. The outer panel 120 may have a hole defined therein, to which the coupling mechanism is coupled, at a location corresponding to the third coupling protrusion 321c.

When assembling the coupling panel 321 to the outer panel 120, an operator may first insert the panel hook 321b of the coupling panel 321 into the outer hook coupling hole 125 of the outer panel 120. In this pre-assembled state, the coupling panel 321 may be placed at a designed location on the outer panel 120.

Thereafter, the operator fixes the third fastening protrusion 321c to the outer panel 120 using a coupling mechanism such as a screw or the like, thereby easily and stably completing the operation of assembling the front coupling portion 24 to the outer panel 120.

In an embodiment, by inserting the panel hook 321b of the coupling panel 321 into the outer hook coupling hole 125 of the outer panel 120, the front coupling portion 24 may be placed at a designed location on the outer panel 120 and may be remained at the corresponding location.

In such a state, the operation of fixing the third fastening protrusion 321c of the coupling panel 321 to the outer panel 120 using the coupling mechanism may be easily performed. This is because the operator does not need a separate operation to maintain the coupling panel 321 at the designed location to fasten the coupling mechanism. Therefore, the ease of assembly of the entire cooking appliance may be improved, and thus, the assembly time may be saved.

FIG. 36 is an exploded view illustrating a portion of the front coupling portion 24 according to an embodiment. FIG. 37 is a cross-sectional view illustrating a portion of the illuminance sensor 3121 in the front coupling portion 24.

The illuminance sensor 3121 may be disposed at a location spaced apart from the rear surface of the coupling panel 321 by a predetermined distance. Because of such a structure, a separation space may be defined in the front and rear direction between the rear surface of the coupling panel 321 and the illuminance sensor 3121 disposed on the front surface of the sensing board 312. In other words, there may be a gap between the illuminance sensor 3121 and the light guide 321d.

The human sensor 3122 disposed on the front surface of the same sensing board 312 may be formed to have a significantly greater volume than the illuminance sensor 3121. Accordingly, to define a space for the human sensor 3122 to be mounted on the coupling panel 321, the separation space is required between the rear surface of the coupling panel 321 and the front surface of the sensing board 312. In addition, the human sensor 3122 may be disposed on an opposite of the illuminance sensor 3121 than the first camera 311.

In an embodiment, by defining the separation space in the front and rear direction between the coupling panel 321 and the illuminance sensor 3121, the human sensor 3122 having the predetermined volume may be disposed in such a separation space. Because of the above-described structure, the human sensor 3122 and the illuminance sensor 3121 disposed on the sensing board 312 may be disposed at the designed locations without being interfered with by the coupling panel 321.

The light guide 321d may be formed at a location corresponding to the illuminance sensor 3121 in the separation space defined between the rear surface of the coupling panel 321 and the front surface of the sensing board 312 to increase a light reception angle and a light reception amount of light incident on the illuminance sensor 3121. This will be described.

The coupling panel 321 may include the light guide 321d protruding rearward from the rear surface of the coupling panel and having the second through-hole 3212 defined therein. The light guide 321d may be integrally formed with the coupling panel 321.

The second through-hole 3212 may be defined inside the light guide 321d. The light guide 321d and the second through-hole 3212 may be formed to have shapes corresponding to each other.

Light around the cooking appliance, that is, light outside the panel 320 may pass through the second through-hole 3212 and enter the illuminance sensor 3121. Accordingly, to increase the amount of light incident on the illuminance sensor 3121, the amount of light received through the second through-hole 3212 may be increased.

In an embodiment, to increase the light reception amount of the illuminance sensor 3121, the second through-hole 3212 may be formed to have a great area size at a front side and have a small area size at a rear side. That is, the second through-hole 3212 may be formed to have a diameter that increases in a forward direction from a location adjacent to the illuminance sensor 3121.

Similarly, the light guide 321d may be formed such that a diameter of an inner surface thereof increases in the forward direction from a location adjacent to the illuminance sensor 3121. That is, the light guide 321d and the second through-hole 3212 may be formed in a cone shape in which a diameter of a front portion is greater than a diameter of a rear portion. However, the present disclosure is not limited thereto. The light guide 321d may be formed in any shape that has a wider diameter of an inner surface away from the illuminance sensor 3121 than a diameter of an inner surface closer to the illuminance sensor 3121.

Because of such a structure, the light reception angle at which external light is incident on the illuminance sensor 3121 may be widened, compared to a case in which the diameters of the front and rear portions of the second through-hole 3212 are equal to each other. Accordingly, the light reception of the illuminance sensor 3121 may be improved, so that the illuminance sensor 3121 may accurately measure the external illuminance, and thus, performance thereof may be improved.

An end of the light guide 321d and the front surface of the sensing board 312 may be disposed to be spaced apart from each other in the front and rear direction.

In one example, the illuminance sensor 3121 may be formed to protrude from the front surface of the sensing board 312, and the front surface of the illuminance sensor 3121 may be disposed to be spaced apart from the end of the light guide unit 321d in the front and rear direction.

When the light guide 321d and the front surface of the sensing board 312 are disposed to be in contact with each other, light leakage may be reduced at the end of the light guide 321d, but there is a risk of damage to the sensing board 312 with which the light guide 321d is in contact. In addition, during the assembly process of the components, the illuminance sensor 3121 disposed on the front surface of the sensing board 312 may be damaged by being in contact with the light guide 321d.

Therefore, in an embodiment, by separating the light guide 321d and the sensing board 312 from each other in the front and rear direction with the above-described structure, damage to the sensing board 312 and the illuminance sensor 3121 may be suppressed, and ease of assembly of the components may be increased.

The cover window 323 may be disposed in front of the second through-hole 3212. That is, the cover window 323 may be disposed in front of the light guide 321d in which the second through-hole 3212 is defined, and may cover a front side of the second through-hole 3212.

Because of such a structure, the foreign substances such as oil vapor may be effectively suppressed from flowing through the second through-hole 3212 and adhering to the illuminance sensor 3121 disposed at the location corresponding to the second through-hole 3212, thereby improving the performance of the illuminance sensor 3121. Accordingly, performance of the illuminance sensor 3121 may be improved over time.

FIG. 38 is a cross-sectional view for illustrating the light guide 321d according to another embodiment. The light guide 321d may include, on an inner surface thereof, a reflective plate 321d1 that is formed to surround the second through-hole 3212 and reflects at least a portion of light introduced into the second through-hole 3212.

The reflective plate 321d1 may be formed in a shape corresponding to the second through-hole 3212. The reflective plate 321d1 may be made of a material having high light reflection efficiency. The reflective plate 321d1 may increase the incident light reception amount by reflecting light incident to a front entrance of the second through-hole 3212 and transmitting the light to the illuminance sensor 3121.

Light incident to the second through-hole 3212 from the outside may be repeatedly reflected by the reflective plate 321d1 and be incident to the illuminance sensor 3121. Accordingly, the light reception amount of the illuminance sensor 3121 may be increased by the reflection plate 321d1, compared to the case in which the reflection plate 321d1 is not present, thereby improving the performance of the illuminance sensor 3121.

FIG. 39 is a view for illustrating a light reception angle according to each embodiment of the light guide 321d.

The reflective plate 321d1 may be formed such that a diameter of an inner surface thereof increases in the forward direction from a location adjacent to the illuminance sensor 3121, and may reflect light incident to the front entrance of the second through-hole 3212 and increase the light reception angle of light incident to the second through-hole 3212.

Referring to FIG. 39, when there is no reflective plate 321d1, the inner surface of the light guide portion 321d is not able to reflect light. Accordingly, in this case, an angle A, which is an angle formed by a pair of symmetrical straight lines extending from an inclined edge of the second through-hole 3212, becomes the light reception angle of the illuminance sensor.

On the other hand, when the reflective plate 321d1 is present, because the inner surface of the light guide 321d reflects light, the light reception angle may become wider. In this case, an angle B, which is an angle formed by a pair of symmetrical straight lines, connecting an edge of the fourth through-hole 3223 of the cover panel 322 with a front end of the reflective plate 321d1, becomes the light reception angle of the illuminance sensor.

It is natural that the angle B is greater than the angle A. Accordingly, when the reflective plate 321d1 is present, the light reception angle of the illuminance sensor 3121 is increased compared to the case in which the reflective plate 321d1 is not present, and accordingly, the light reception amount of the illuminance sensor 3121 is increased.

In an embodiment, the reflective plate 321d1 may be formed in the cone shape to reflect light incident to the front entrance of the second through-hole 3212 to increase the light reception angle of light incident to the second through-hole 3212, thereby effectively increasing the light reception amount of the illuminance sensor 3121.

Although the present disclosure has been described with reference to the accompanying drawings, the present disclosure is not limited by the embodiments disclosed herein and the drawings, and it is obvious that various modifications may be made by those skilled in the art within the scope of the technical idea of the present disclosure. In addition, although the effects based on the configuration of the present disclosure are not explicitly described and illustrated in the description of the embodiment of the present disclosure above, it is natural that predictable effects of the corresponding configuration should also be recognized.

What is claimed is:

1. A cooking appliance comprising:
a main body including a cavity; and
a door configured to open and close the cavity, the door including:
a display module located at a front portion of the door;
an outlet configured to discharge air flowing inside the door; and
a panel configured to guide a flow direction of air discharged from the outlet downward to an outside of the cooking appliance.

2. The cooking appliance of claim 1, wherein the outlet is located at an upper portion of the door and overlaps the panel in a front and rear direction, and
wherein the panel is located to cover a front side of the outlet.

3. The cooking appliance of claim 2, wherein the air flowing inside the door is discharged forward through the outlet, and is blocked by the panel, thereby changing the flow direction of the air discharged to a downward direction.

4. The cooking appliance of claim 2, wherein a lower end of the panel protrudes further downward than a lower end of the outlet.

5. The cooking appliance of claim 2, wherein the air discharged from the outlet is discharged forward and collides with a rear surface of the panel, thereby changing the flow direction of the air discharged toward an open lower portion between the panel and the outlet.

6. The cooking appliance of claim 2, wherein the door further includes a bezel,
wherein the display module includes a display configured to display an image thereon,
wherein the panel at least partially overlap the bezel in the front and rear direction, and
wherein the bezel is located at an edge of the display.

7. The cooking appliance of claim 6, wherein the door includes a front coupling portion including the panel, and
wherein a gap is located between a lower portion of the front coupling portion and a front surface of the display, the gap being configured to allow air to be discharged therethrough.

8. The cooking appliance of claim 6, wherein the air discharged from the outlet is discharged downward toward the door by the panel so that at least a portion of the air discharged comes into contact with a front surface of the display.

9. The cooking appliance of claim 6, wherein the panel is located in front of the display in the front and rear direction and is located so as to be spaced apart from the display.

10. The cooking appliance of claim 9, wherein the panel includes a coupling panel, the coupling panel having a maximum length that extends in a same direction as a lateral direction of the door, and
wherein a rear surface of the coupling panel protrudes further forward than a front surface of the display in the front and rear direction.

11. The cooking appliance of claim 1, wherein the display module includes:
a display configured to display an image thereon; and
an outer panel located at a rear of the display, the display being mounted to the outer panel,
wherein the outlet includes:
a first outlet located at an upper portion of the outer panel, the first outlet being configured to allow air flowing inside the door to be discharged to the outside therethrough; and
a second outlet located at a lower portion of the outer panel, the second outlet being configured to allow air flowing inside the door to be discharged to the outside therethrough, and
wherein the panel is located in front of the first outlet in a front and rear direction.

12. The cooking appliance of claim 11, wherein a lower end of the panel protrudes further downward than a lower end of the first outlet so that air discharged from the first outlet is guided by the panel to change a flow path of the air discharged from the first outlet to a downward direction.

13. A cooking appliance comprising:
a main body including a cavity; and
a door configured to open and close the cavity, the door including:
a display module located at a front portion of the door;
a sensing module located on an upper front portion of the display module, the sensing module being configured to sense a presence of a user; and
a panel positioned on the upper front portion of the display module, the panel being configured to cover the sensing module.

14. The cooking appliance of claim 13, wherein the sensing module includes:
a camera configured to capture a space in front of the cooking appliance;
an illuminance sensor configured to sense external illuminance to the cooking appliance; and
a human sensor configured to sense the presence of the user in front of the cooking appliance,
wherein the panel includes:
a coupling panel having a maximum length extending in a same direction as a lateral direction of the door, and the camera, the illuminance sensor, and the human sensor being located on the coupling panel;
a cover panel configured to cover at least a portion of the coupling panel; and
a cover window located between the coupling panel and the cover panel, the cover window being configured to cover a front side of the camera, a front side of the illuminance sensor, and a front side of the human sensor, the cover window being transparent.

15. The cooking appliance of claim 14, wherein the cover window includes an exposure hole located opposite the human sensor to expose a portion of a front surface of the human sensor to an outside of the cooking appliance.

16. The cooking appliance of claim 15, wherein the coupling panel includes:
a first through-hole opposite the camera;
a second through-hole laterally spaced apart from the first through-hole, the second through-hole being opposite the illuminance sensor; and
a third through-hole laterally spaced apart from the first through-hole and the second through-hole, the third through-hole being opposite the human sensor.

17. The cooking appliance of claim 16, wherein the exposure hole overlaps the third through-hole, and
wherein a size of the exposure hole is smaller than a size of the human sensor.

18. The cooking appliance of claim 16, wherein the coupling panel further includes a holder protruding rearward from a rear surface of the coupling panel, the holder being configured to surround the third through-hole, and
wherein the human sensor is mounted to the holder.

19. The cooking appliance of claim 18, wherein the sensing module further includes a sensing board having a front surface to which the illuminance sensor and the human sensor are mounted,
wherein the coupling panel further includes:
a fastening protrusion protruding rearward from the rear surface of the coupling panel, the fastening protrusion being fastened to the sensing board by a coupling mechanism; and
a mounting protrusion protruding rearward from the rear surface of the coupling panel, the mounting portion being spaced apart from the fastening protrusion, and
wherein an end of the sensing board is mounted to the mounting protrusion.

20. The cooking appliance of claim 19, wherein the holder includes:
a base protruding portion protruding from the coupling panel, the base protruding portion having a circumferential shape; and
an additional protruding portion protruding from a portion of the base protruding portion, the additional protruding portion having an arcuate shape.
